(19) United States
(12) Patent Application Publication
(10) Pub. No.: US 2025/0073934 A1
(43) Pub. Date: Mar. 6, 2025

(54) KNIFE

(71) Applicant: MARTOR KG, Solingen (DE)

(72) Inventor: Martin ROHRBACH, Göggingen (DE)

(21) Appl. No.: 18/749,985

(22) Filed: Jun. 21, 2024

(30) Foreign Application Priority Data
Jul. 11, 2023 (DE) 10 2023 118 318.4

(51) Int. Cl. B26B 1/08; B26B 5/00

(52) U.S. Cl. CPC B26B 1/08; B26B 5/003

(57) ABSTRACT

A knife including a first actuating part and a second actuating part of an actuating device, which forms a joint together with the first actuating part and can be pivoted in a first direction out of an unactuated position about a part pivot axis relative to the first actuating part in order to move a blade device that is movable relative to the first actuating part and the second actuating part and can be pivoted in a second direction in order to move the second actuating part into a blade-change position. An adjustment device is provided that has a control element by which the movement of the second actuating part in relation to at least one direction can be blocked.

The invention relates to a knife.

A knife of this kind comprises an actuating device having a first actuating part, which forms a pivot joint together with a second actuating part. The second actuating part can be pivoted relative to the first actuating part in the manner of a pair of pliers between an unactuated position and an actuated position about a part pivot axis in order to move a blade device that is movable relative to the first actuating part and the second actuating part and has a blade secured thereto between a rest position and a cutting position. In the rest position, access to the blade is e.g. blocked by knife regions such that the user cannot injure themselves. In the cutting position, a cutting process is possible, for example.

There are different technical solutions for moving the blade carrier between the rest position and the cutting position by means of the first actuating part and the second actuating part. One suitable solution of these solutions is used in the knife according to the invention. It is essential that the drive is produced on the basis of the relative movement of the first actuating part and the second actuating part.

A knife comprising two actuating parts is known from EP 2 807 001 A1. The knife comprises a securing device for blocking the movement of a second actuating part relative to a first actuating part. A handle of the securing device can be moved out of a secured position into positions in different directions.

The problem addressed by the invention was to provide a knife comprising a first actuating part and a second actuating part that can be pivoted relative to the first actuating part and comprising an adjustment device for setting different operating states of the knife which has a low number of parts and has advantages in terms of manufacturing.

In the knife according to the invention, a first actuating part and a second actuating part of an actuating device form a joint such that the second actuating part can be pivoted relative to the first actuating part in the manner of a pair of pliers in opposite pivot directions about a part pivot axis. The part pivot axis extends e.g. approximately at right angles to a sagittal plane of the knife. The movement of the second actuating part relative to the first actuating part takes place within the sagittal plane. A central longitudinal axis of the knife e.g. lies within the sagittal plane of the knife.

When the second actuating part is moved in a first pivot direction relative to the first actuating part between an unactuated and an actuated position, a blade device is moved between a rest position and at least one cutting position. The movement of the second actuating part out of the unactuated position in a second pivot direction into a blade-change position provides access to the blade device, i.e. for changing it or for changing a blade mounted in the blade carrier. Within the meaning of the invention, “blade device” can mean a one-piece blade having a cutting edge, with no blade carrier being provided. However, the term “blade device” also includes devices in which blades are non-detachably or detachably fastened in a blade carrier.

The knife comprises an adjustment device comprising at least one locking device, by means of which the operating state of the knife can be selected at least between an operating position, a secured position and a blade-change position. In the secured position, a movement of the second actuating part out of the unactuated position into an actuated position and therefore a movement of the blade carrier from the rest position into the cutting position is not possible. Furthermore, a movement into the blade-change position is not possible.

In the operating position, the second actuating part can be moved relative to the first actuating part in a first direction between the unactuated position and the actuated position and therefore the blade device can be moved between the rest position and the cutting position. A movement into the blade-change position is not possible in the operating position.

In the blade-change position, the second actuating part cannot be moved out of the unactuated position into the actuated position. The second actuating part can be moved into the blade-change position, however. In the blade-change position, the blade device is accessible.

In the knife according to the invention, the blade device is prevented from moving by a relative movement of the first actuating part and the second actuating part from the unactuated position into the actuated position being prevented.

The adjustment device comprises at least one locking device, by means of which the movement of the second actuating part can be blocked in relation to a first movement direction, a second movement direction or in relation to both movement directions. For example, two locking devices are present in order to provide increased safety.

The locking device e.g. comprises at least two securing surfaces, which are arranged opposite one another and are assigned to one of the actuating parts, and at least two counter surfaces, which are spaced apart from one another and are formed on the control element, which is assigned to the other of the actuating parts. The counter surfaces are e.g. spaced apart from one another such that the securing surfaces can be arranged between the counter surfaces in relation to a movement of the control element.

In the respective positions of the control element, e.g. a first pair or a second pair of securing surfaces and counter surfaces interact, or e.g. both pairs interact.

The securing surfaces or the counter surfaces are formed on the pivotable control element. Surface regions of the securing surfaces and the counter surfaces can e.g. be positioned so as to be offset relative to one another by means of the control element such that the movement of the second actuating part in a first pivot direction, in a second pivot direction and in both pivot directions can be blocked as desired. The surface regions of the securing surfaces can be assigned to one structure or to different structures. Likewise, the surface regions of the counter surfaces can be assigned to one structure or to different structures.

By means of the adjustment device according to the invention, the different operating states of the knife can be set with a small amount of space and few parts.

The locking device of the adjustment device is e.g. designed such that the setting of the control element in the secured position is arranged between the settings in the blade-change position or in the operating position in relation to the control order of the control element. When moving the second actuating part out of the blade-change position into the unactuated position, the knife can then automatically be secured in the secured position of the locking device, such that the risk of injury is reduced. Specifically, it is then not possible for the user to accidentally move the second actuating part into the actuated position during this movement and for the blade device to be moved into the cutting position in the process.

The control element is e.g. translationally or rotationally adjustable between the operating position, the secured position and the blade-change position. A translational movement can be linear or on an at least partially curved path.

For example, the adjustment device comprises two locking devices.

Parts of a first and a second locking device can be synchronised with one another, such that they are moved in the same way. For example, the control element comprises parts of the first locking device and the second locking device. The control element e.g. comprises a pair of securing surfaces and/or counter surfaces that is opposite in relation to the sagittal plane of the knife, each of the securing surfaces interacting with a counter surface. By means of these features, an even load and greater safety is obtained, because there is a redundant structure if one of the structures fails.

In the application, the term “securing surfaces” can mean a plurality of surface regions of one contiguous securing surface or a plurality of separate securing surfaces. Likewise, the term “counter surfaces” can mean a plurality of surface regions of one counter surface or a plurality of separate counter surfaces.

The securing surface and/or the counter surface are e.g. at least partially circular cylindrical. That is to say that, for example, one of the surfaces can be fully cylindrical and the other can be partially circular cylindrical. The term “partially circular cylindrical” means that the cylindrical structure is formed in the cross section of a partial circle. At least one of the two surfaces can e.g. surround the other surface such that a movement of the second actuating part in at least one pivot direction is prevented.

The securing surface and/or the counter surface are e.g. arranged coaxially with the element pivot axis in the unactuated position. If the securing surface and the securing counter surface are arranged to be partially circular cylindrical, the two surfaces or surface regions can be moved into engagement and out of engagement in this way by rotating the control element.

The securing surfaces and the counter surfaces are e.g. formed on a rear end region of the first actuating part and the second actuating part. The rear end region is arranged to be opposite the pivot joint between the first actuating part and the second actuating part. For this reason, the movement of the second actuating part in one or both of the movement directions can be prevented owing to the lever action at the rear end region with relatively little force being applied. Furthermore, this region is not located within the movement range of the blade device.

The securing surface and/or the counter surface is e.g. formed on a projection of the first actuating part or the second actuating part. When the knife parts of the knife in the unactuated position are designed such that the first actuating part is spaced apart from the second actuating part, it is possible to form one or both of the surface types of the securing surfaces and counter surfaces on a projection of the first actuating part or on a projection of the second actuating part. Despite the spacing of the actuating regions of the first actuating part and the second actuating part, the securing surfaces and the counter surfaces can be moved into engagement and out of engagement in a rear region of the knife.

In the secured position, the securing surface e.g. interacts with at least one counter surface such that a pivoting movement of the second actuating part into the cutting position and into a blade-change position is blocked. By means of the securing surfaces and the counter surfaces, in this position of the control element two opposite movement directions of the second actuating part are blocked. The movement of the second actuating part into the actuated position is blocked by means of a first securing surface and a first counter surface and the movement into the blade-change position is blocked by means of a second securing surface and a second counter surface.

In an operating position of the control element, a second securing surface and a second counter surface interact in a blocking manner such that a movement of the second actuating part from the unactuated position into the actuated position is possible, while the movement out of the unactuated position into the blade-change position is blocked.

In a blade-change position of the control element, a movement into the cutting position is blocked and a movement of the second actuating part into the blade-change position is enabled, for example. The first securing surface and the first counter surface block a movement into the actuated position. The second securing surface and the second counter surface can move past one another. In the blade-change position of the control element, the second actuating part can be moved into the blade-change position in order to provide access to the blade device. In addition, the blocking of the movement of the second actuating part into the actuated position may be useful so that the blade device is not accidentally moved into the cutting position when changing the blade, posing a risk of injury to the user.

The control element e.g. comprises a sprung latch element, which is moved into interlocking engagement with a counter latching structure in at least one of the set positions, i.e. the secured position, the operating position or the blade-change position. This ensures that the control element is not inadvertently moved out of the set position. The latch element is e.g. formed in one piece with the control element. Alternatively, however, the latch element can also be fastened to the control element.

The control element e.g. comprises a restoring element, which loads the control element into the secured position. By means of the automatic restoring of the control element e.g. out of the blade-change position into the secured position, it can be ensured that the second actuating part is automatically in engagement with the control element in the secured position during the restoring into the unactuated position, with the securing surface and the counter surface being in engagement.

According to an embodiment, the geometric element pivot axis extends approximately at right angles to the sagittal plane of the knife.

The element pivot axis is e.g. arranged approximately in parallel with the part pivot axis. In particular, the element pivot axis is e.g. transverse to a sagittal plane of the knife.

The control element can e.g. comprise a control lug, which is positioned on a side region of the knife. A user can adjust the adjustment device by the control lug.

A securing structure comprising at least one securing surface and a counter structure comprising at least one counter surface are e.g. designed to comprise interacting oblique surfaces, in order to move the control element out of the blade-change position into the unactuated position when the second actuating part moves so that the securing surface and the counter surface can be moved past one another. When the control element is loaded into the secured position by a spring, this ensures that the locking device can be moved back into the secured position after the return movement of the second actuating part into the unactuated position. This is only possible if the second actuating part is in the unactuated position.

Exemplary embodiments of the invention are described by way of example in the following description of the figures, also with reference to the drawings. Here, for the sake of clarity, even if different exemplary embodiments are involved, identical or comparable parts or elements or regions have been denoted by identical reference signs, sometimes with the addition of lower case letters.

Features that are only described in relation to one exemplary embodiment can also be provided in any other exemplary embodiment of the invention within the scope of the invention. Even if they are not shown in the drawings, such amended exemplary embodiments are covered by the invention.

All the features disclosed are essential to the invention per se. The content of the disclosure of the cited documents and the prior art devices described are hereby incorporated into the disclosure of the application in their entirety, also for the purpose of incorporating individual features or a plurality of features of these documents into one or more claims of the present application.

In the drawings:

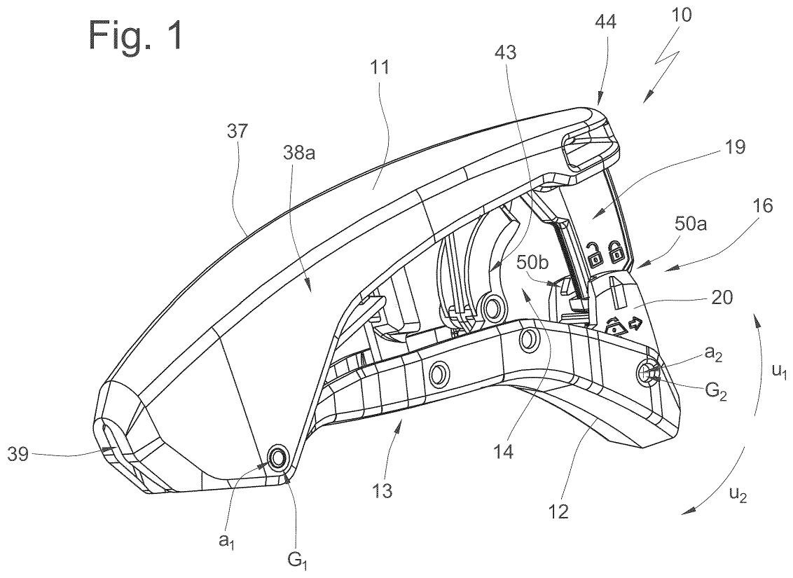

FIG. 1 is a perspective view of a first exemplary embodiment of the knife according to the invention in an unactuated position,

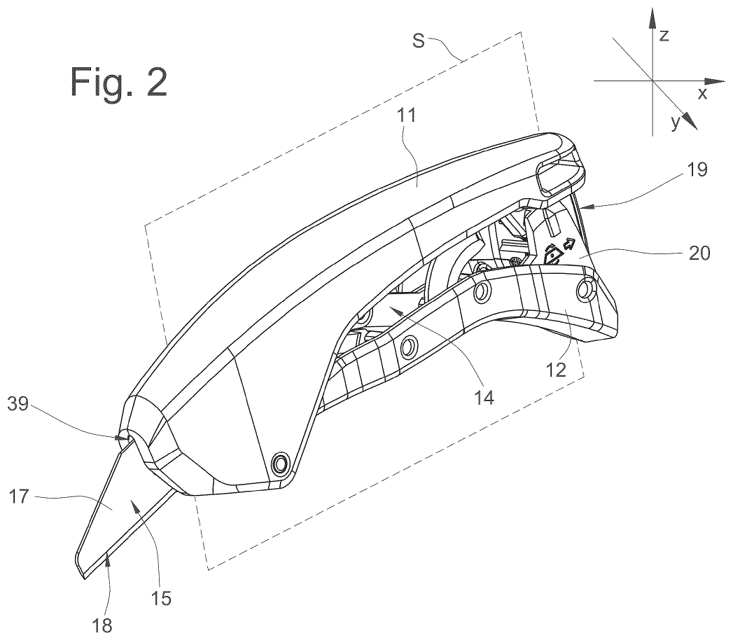

FIG. 2 is a perspective view based on FIG. 1, in the actuated position,

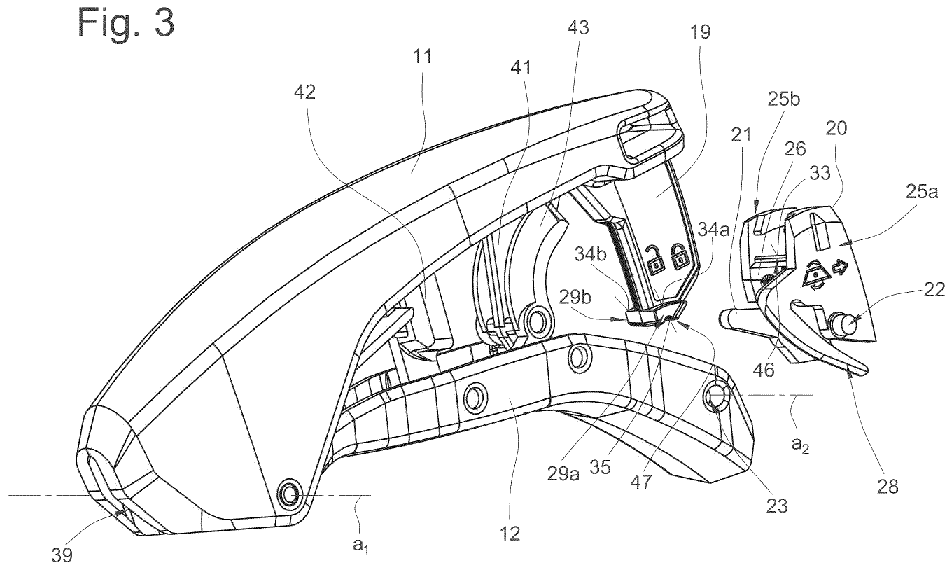

FIG. 3 is a perspective view of the knife, with the control element being shown in an exploded view,

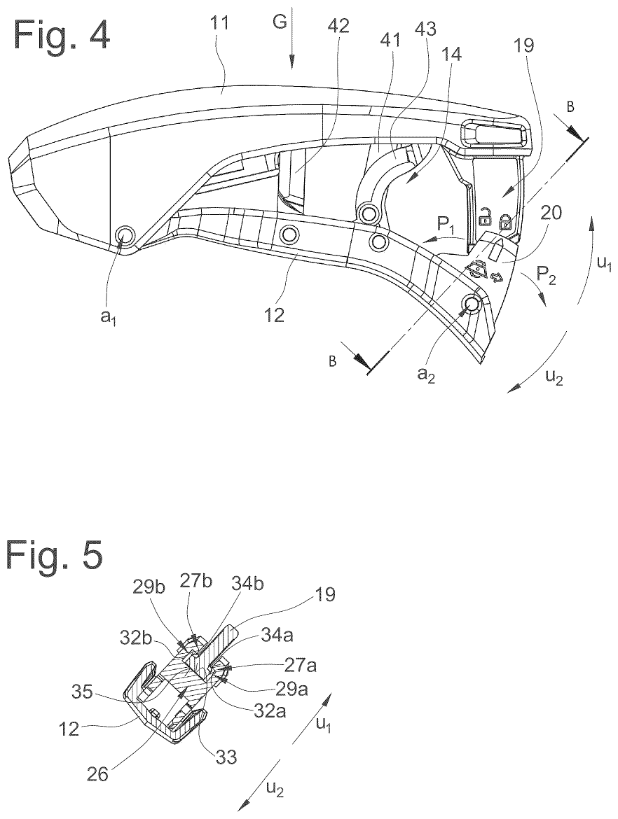

FIG. 4 is a side view of the knife according to FIG. 1, with the control element of an adjustment device being in a secured position,

FIG. 5 is a sectional view along sectional line B-B in FIG. 4,

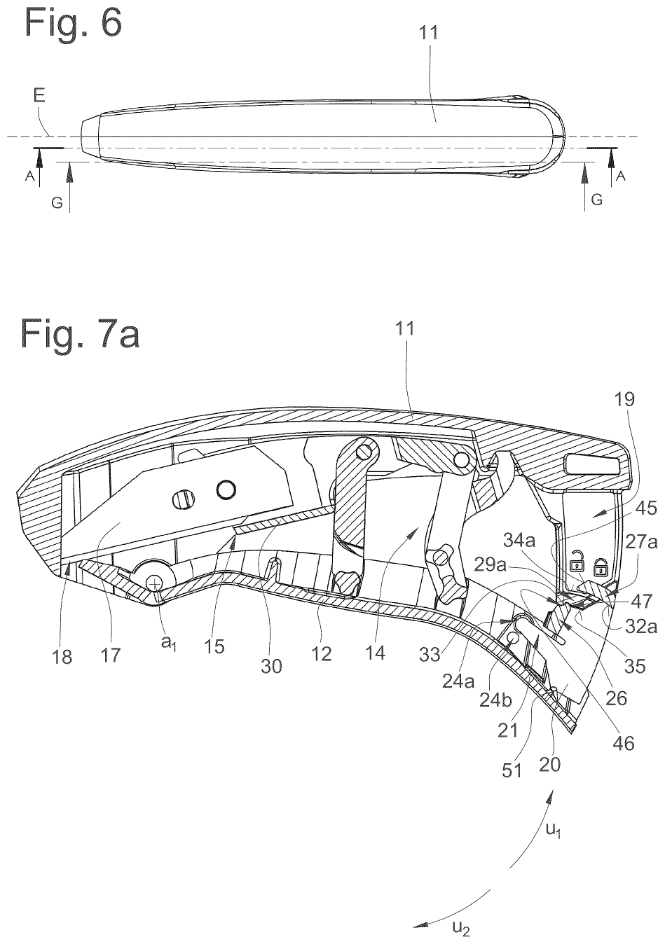

FIG. 6 is a view from the direction of the arrow G in FIG. 4,

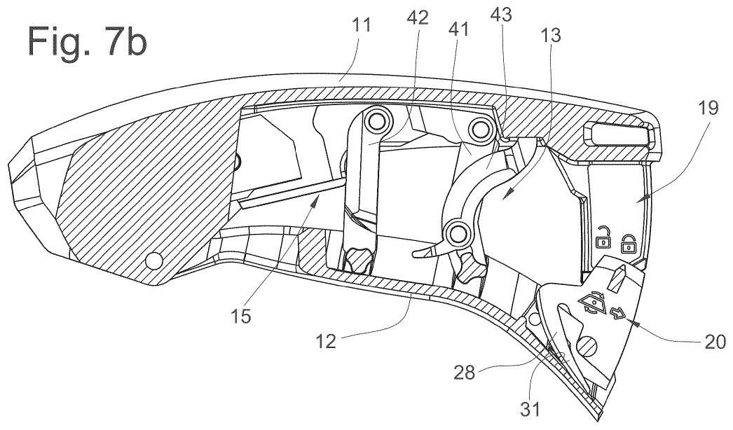

FIG. 7 is a sectional view along sectional line A-A in FIG. 6,

FIG. 7b is a sectional view along sectional line B-B in FIG. 6,

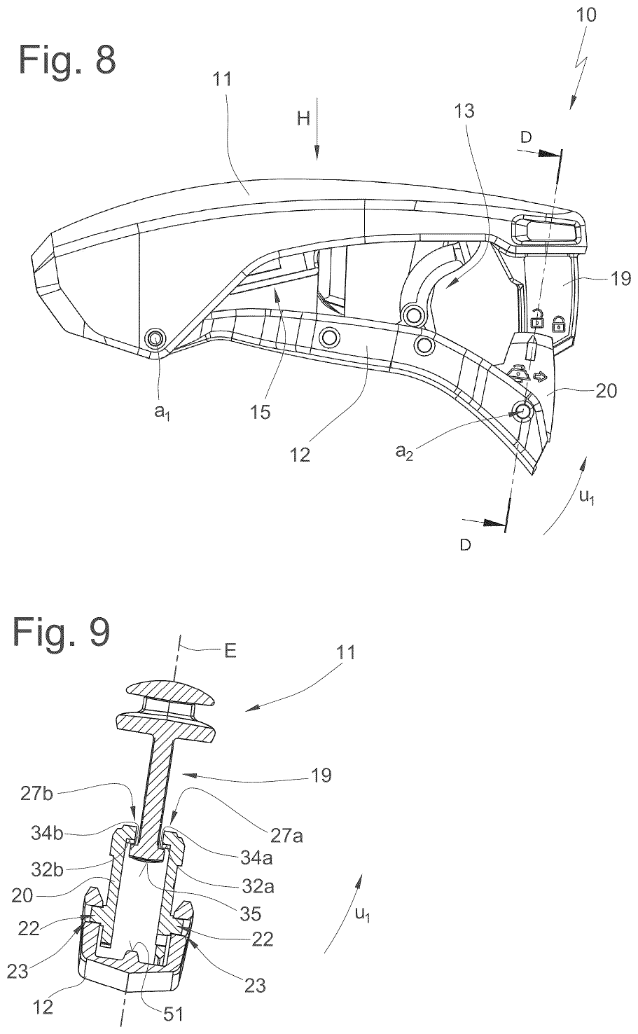

FIG. 8 is a side view of the knife based on FIG. 4, with the control element being in the operating position and the knife being in the unactuated position,

FIG. 9 is a sectional view along sectional line D-D in FIG. 8,

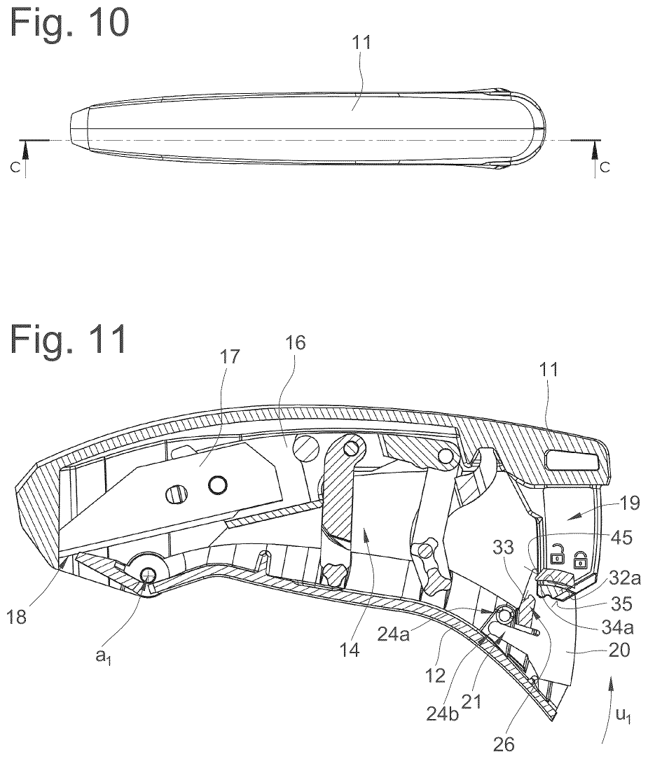

FIG. 10 is a view from the direction of the arrow H in FIG. 8,

FIG. 11 is a sectional view along sectional line C-C in FIG. 10,

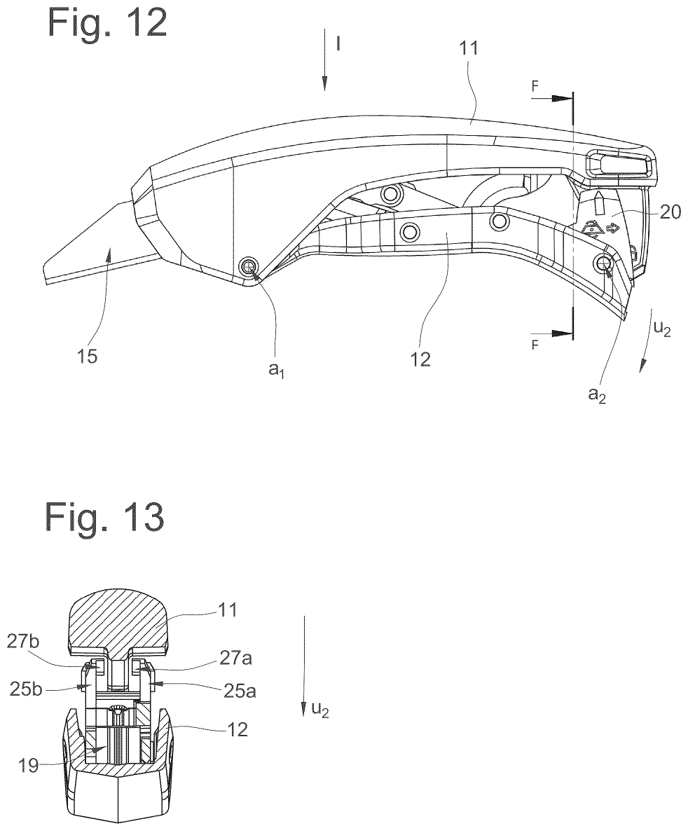

FIG. 12 is a side view based on FIG. 8, with the knife being in the actuated position,

FIG. 13 is a sectional view along sectional line F-F in FIG. 12,

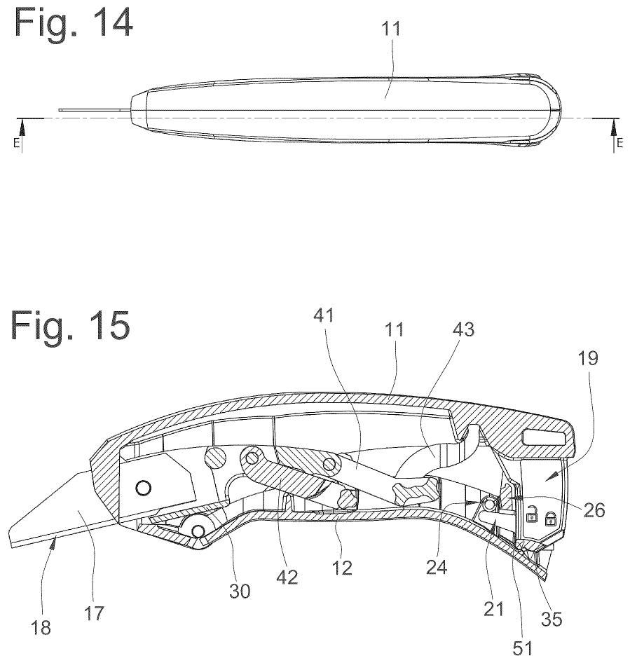

FIG. 14 is a view from the direction of the arrow I in FIG. 12,

FIG. 15 is a sectional view along sectional line E-E in FIG. 14,

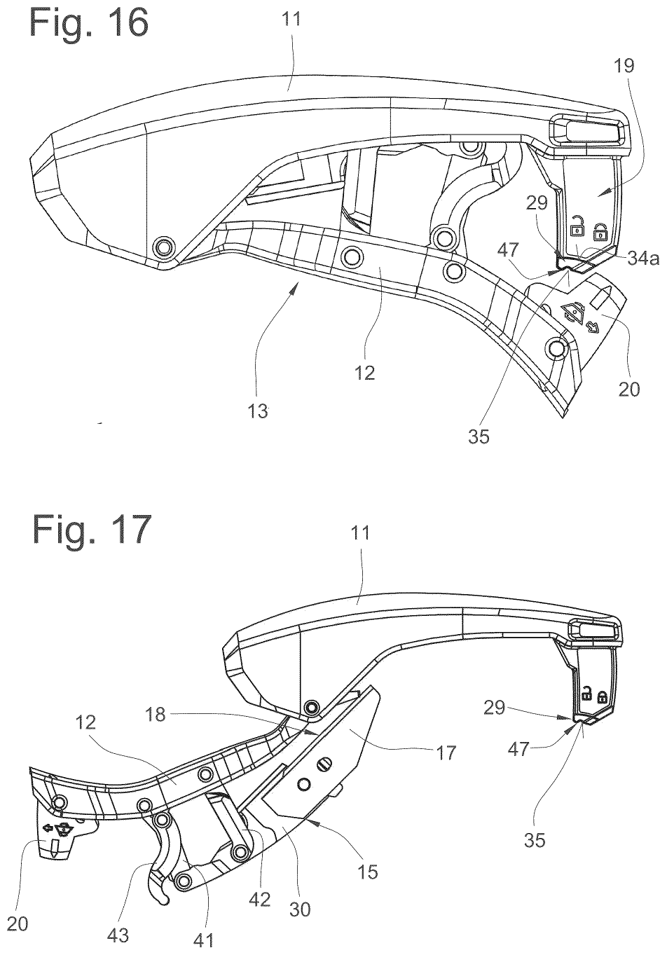

FIG. 16 is a side view of the knife in the unactuated position, with the control element being in the blade-change position,

FIG. 17 is a side view of the knife in the blade-change position,

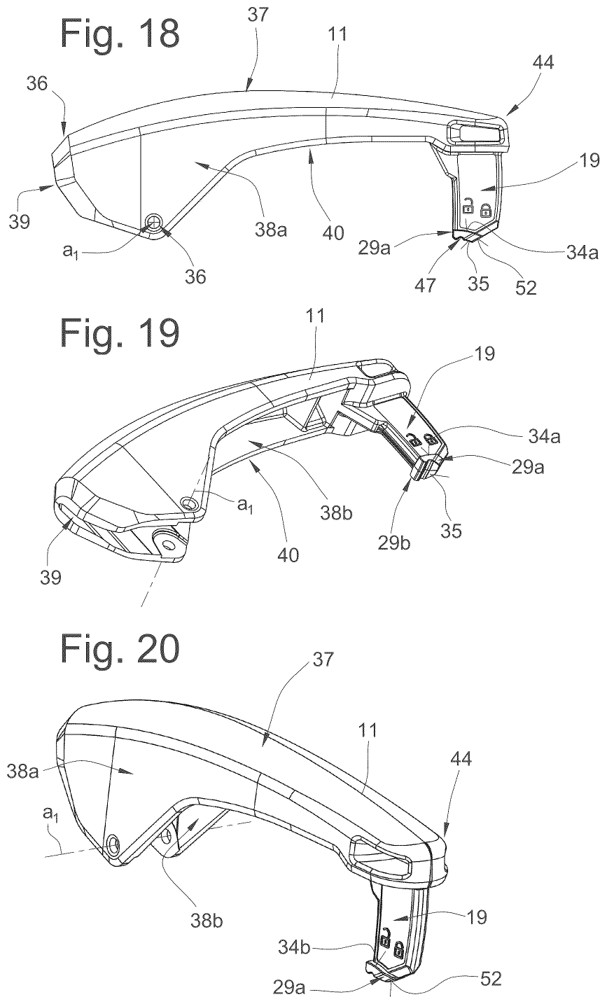

FIG. 18 is a side view of a housing-like first actuating part of the knife,

FIG. 19 is a perspective oblique front view of the first actuating part,

FIG. 20 is a perspective oblique rear view of the first actuating part,

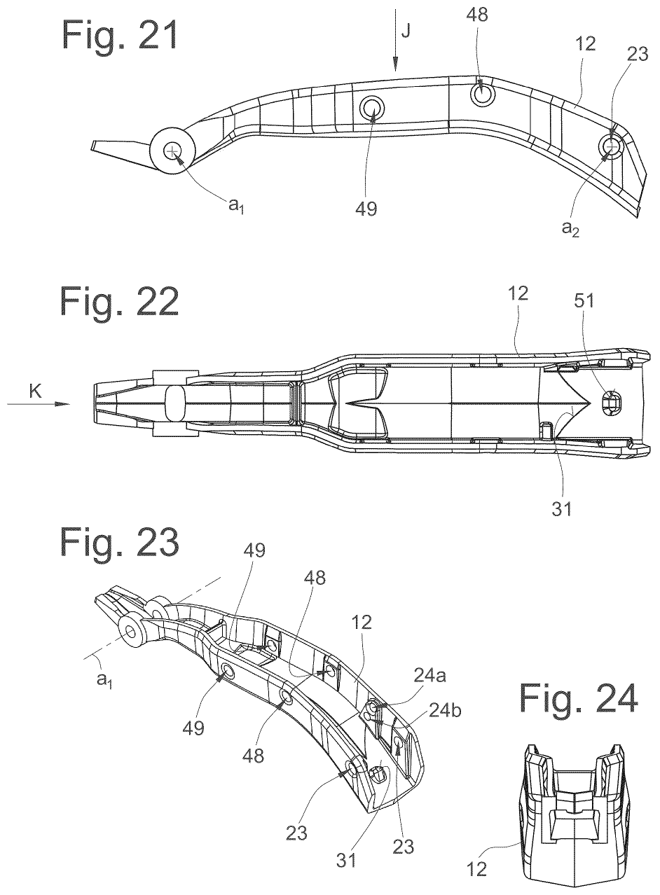

FIG. 21 is a side view of a second actuating part of the knife,

FIG. 22 is a view from the direction of the arrow J in FIG. 21,

FIG. 23 is a perspective oblique rear view of the second actuating part,

FIG. 24 is a view from the direction of the arrow K in FIG. 22,

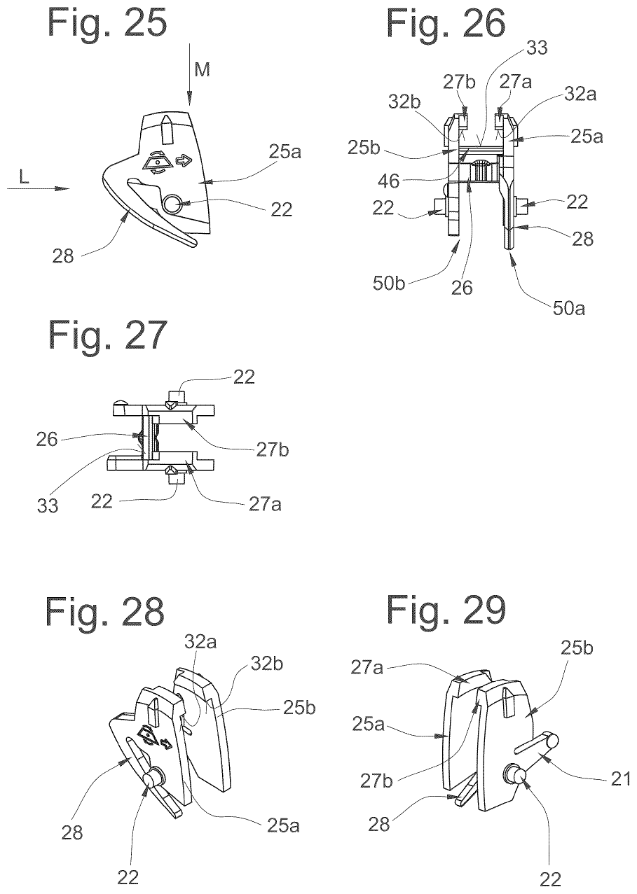

FIG. 25 is a side view of the control element,

FIG. 26 is a view from the direction of the arrow L in FIG. 25,

FIG. 27 is a view from the direction of the arrow M in FIG. 25,

FIG. 28 is a perspective view of the control element from a first side,

FIG. 29 is a perspective view of the control element from a second side opposite the first side,

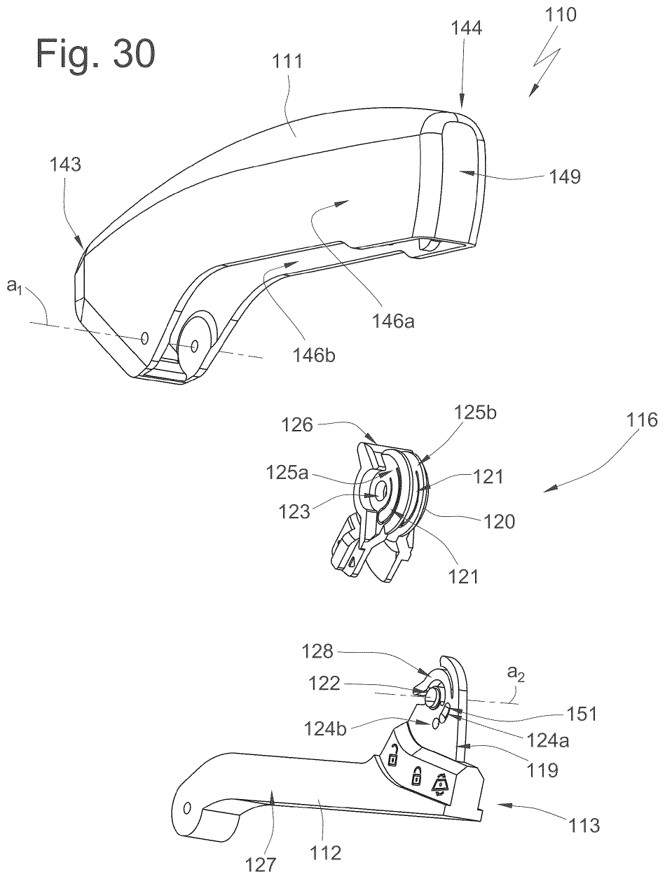

FIG. 30 is an exploded view of a knife according to a second exemplary embodiment of the invention, with a blade device and parts of the actuating device not being shown,

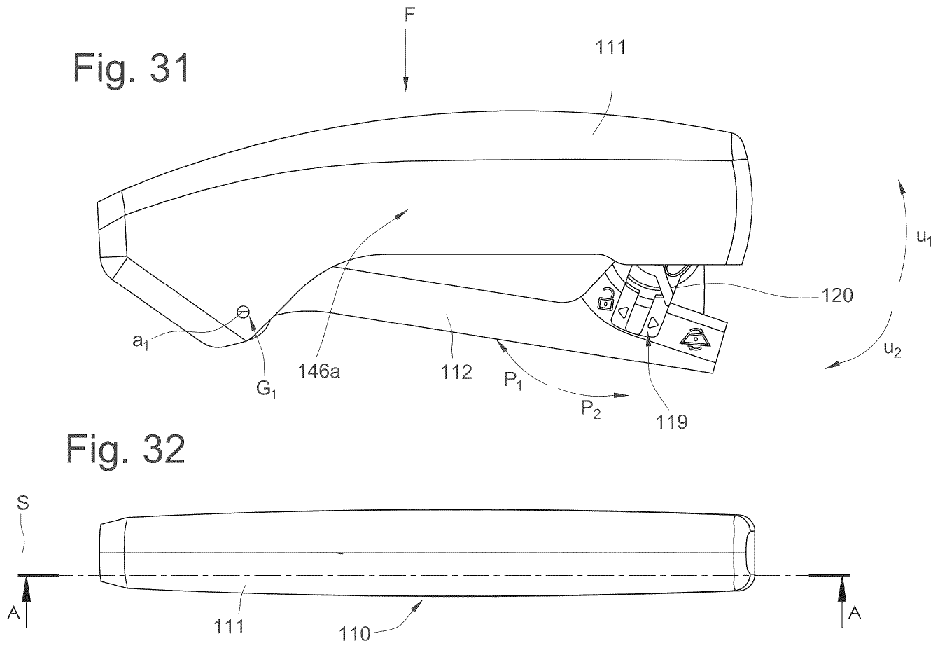

FIG. 31 is a side view of the knife according to FIG. 1, with the adjustment device being in the secured position and the second actuating part being in the unactuated position,

FIG. 32 is a view from the direction of the arrow F in FIG. 31,

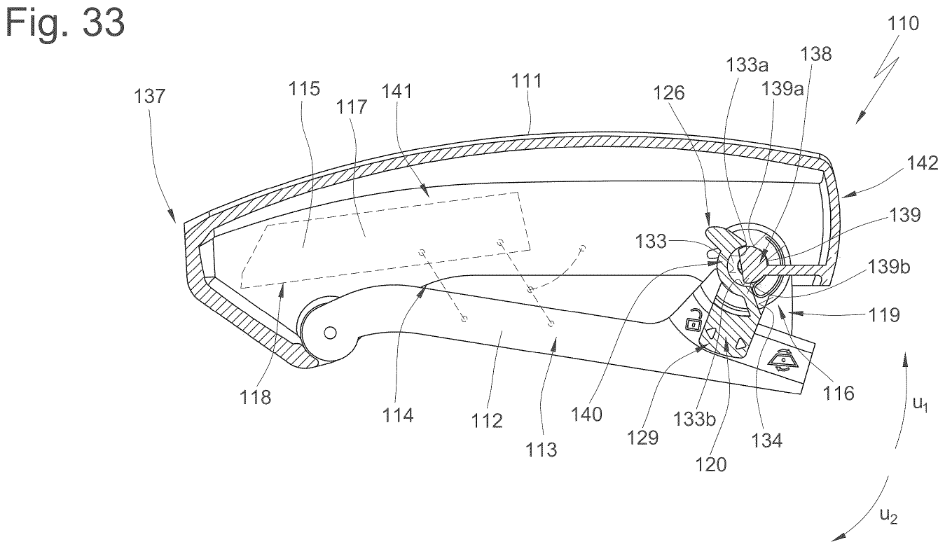

FIG. 33 is a sectional view along sectional line A-A in FIG. 32,

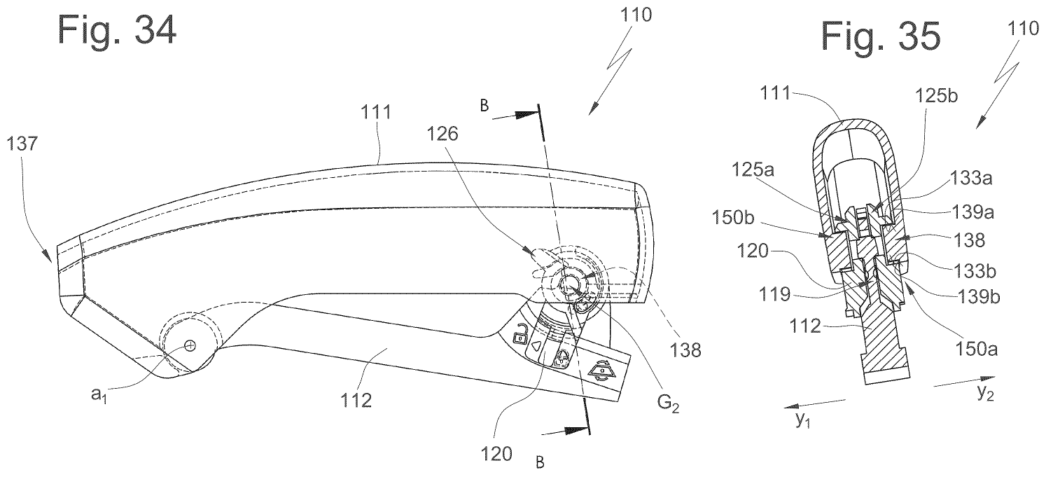

FIG. 34 is the side view according to FIG. 31, with the first actuating part being shown to be transparent,

FIG. 35 is a sectional view along sectional line B-B in FIG. 34,

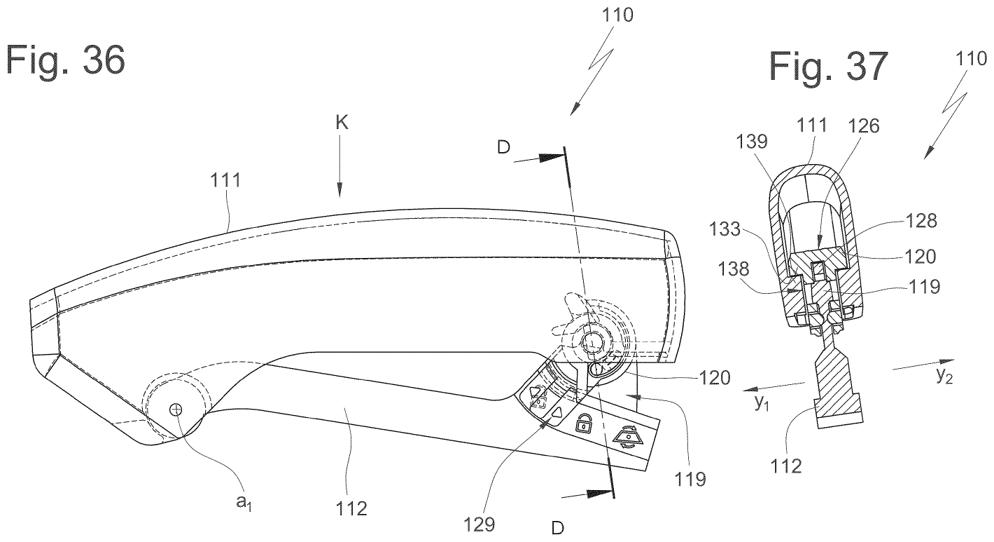

FIG. 36 is a side view of the knife according to FIG. 34, with the adjustment device being set in the operating position,

FIG. 37 is a sectional view along sectional line D-D in FIG. 36,

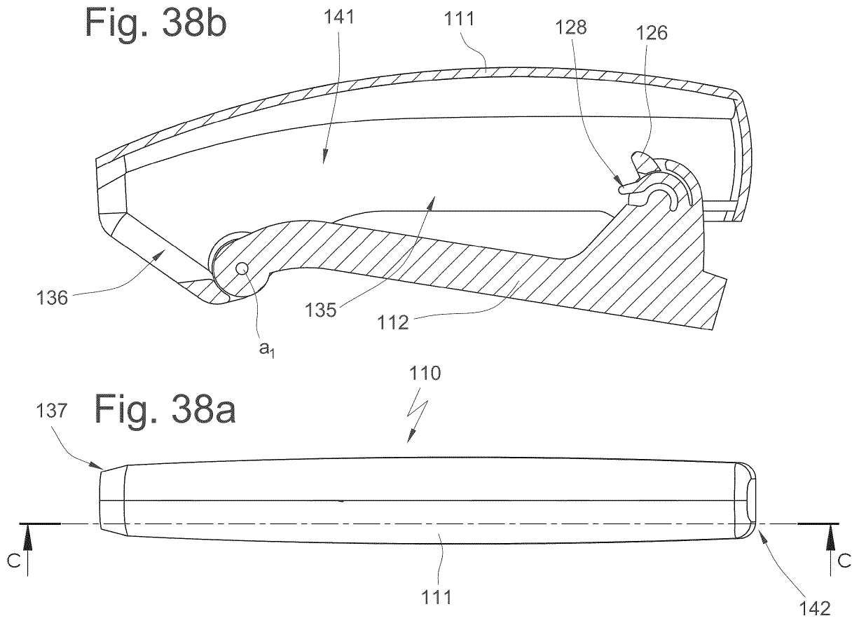

FIG. 38a is a view from the direction of the arrow K in FIG. 36,

FIG. 38b is a sectional view along sectional line C-C in FIG. 38a,

FIG. 39 is a view from the direction of the arrow K in FIG. 36,

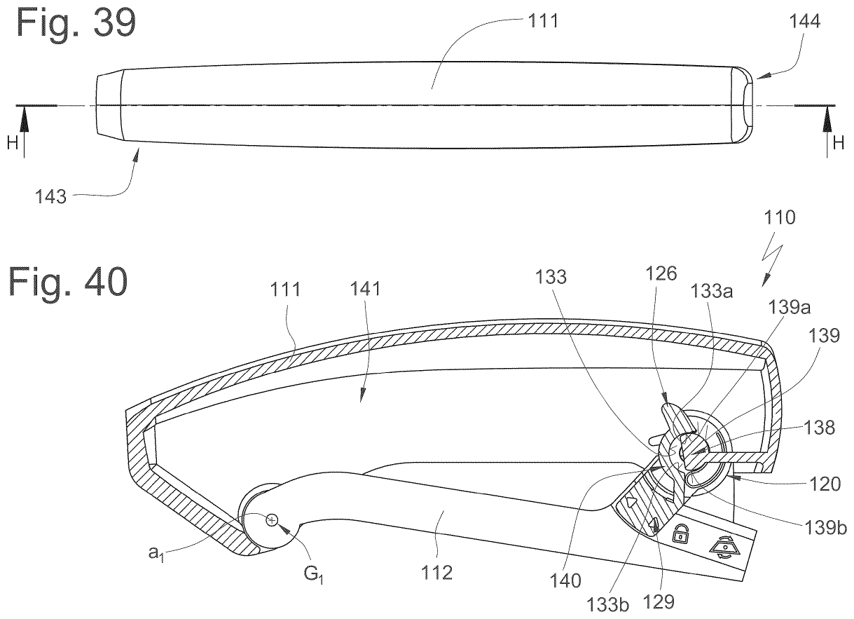

FIG. 40 is a sectional view along sectional line H-H in FIG. 39,

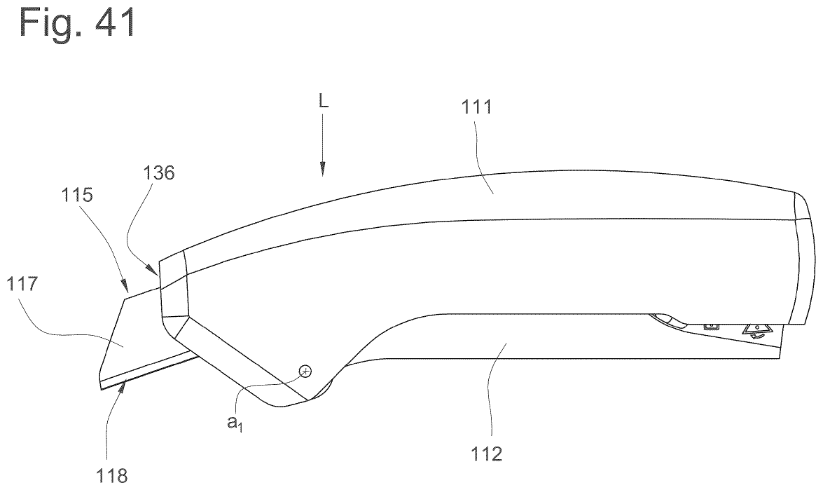

FIG. 41 is a side view of the knife, with the adjustment device being in the operating position and the second actuating part being in the actuated position,

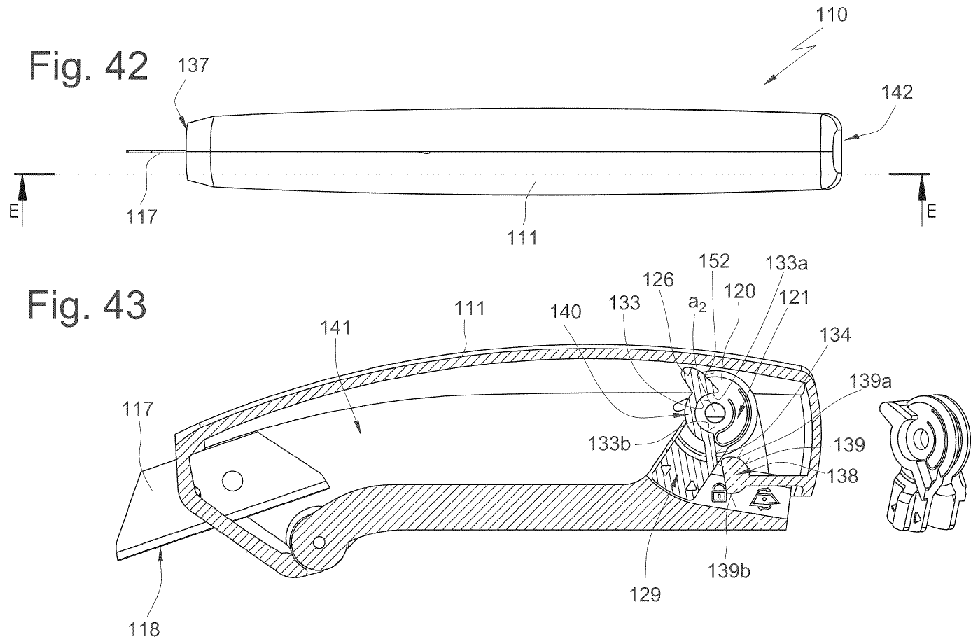

FIG. 42 is a view from the direction of the arrow L in FIG. 41,

FIG. 43 is a sectional view along sectional line E-E in FIG. 42,

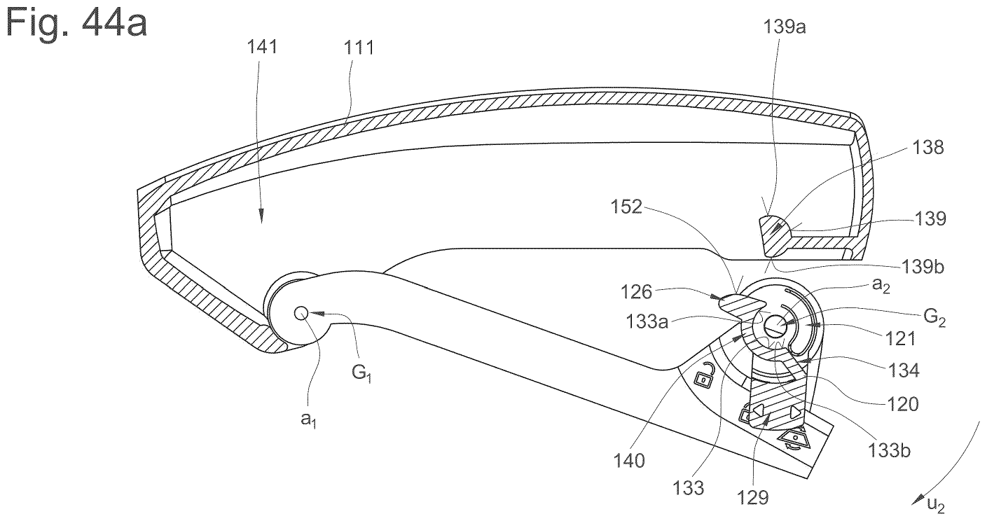

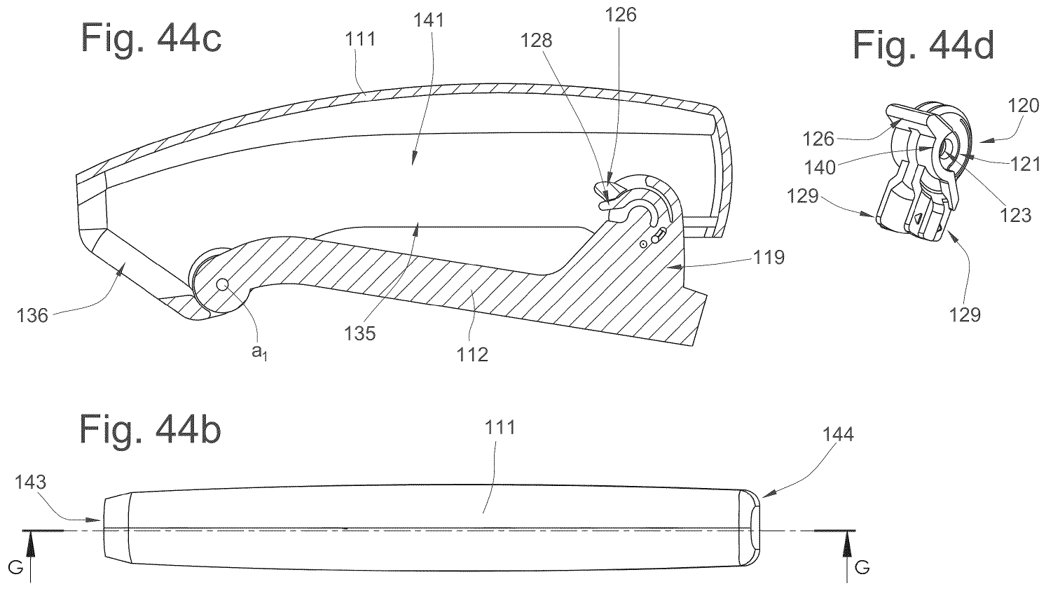

FIG. 44a is a sectional view based on FIG. 43, with the adjustment device being in the blade-change position and the second actuating part being in the blade-change position,

FIG. 44b is a view according to FIG. 42, with the adjustment device being in the blade-change position,

FIG. 44c is a sectional view along sectional line G-G in FIG. 44b,

FIG. 44d is a perspective view of the control element shown as an individual part,

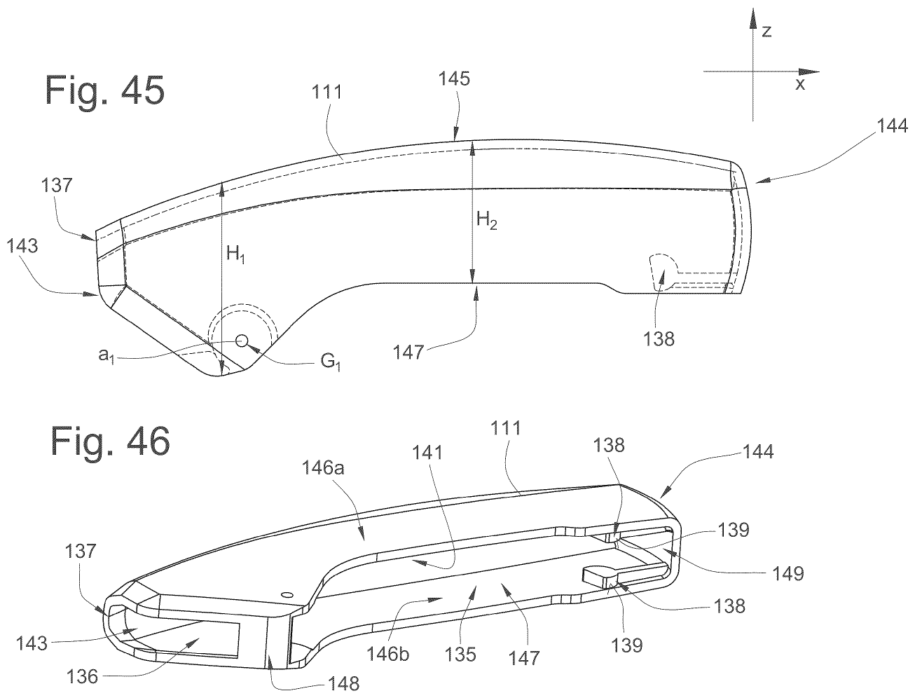

FIG. 45 is a side view of the first actuating part shown as an individual part, with concealed structures being shown by dashed lines,

FIG. 46 is a perspective view of the first actuating part according to FIG. 45,

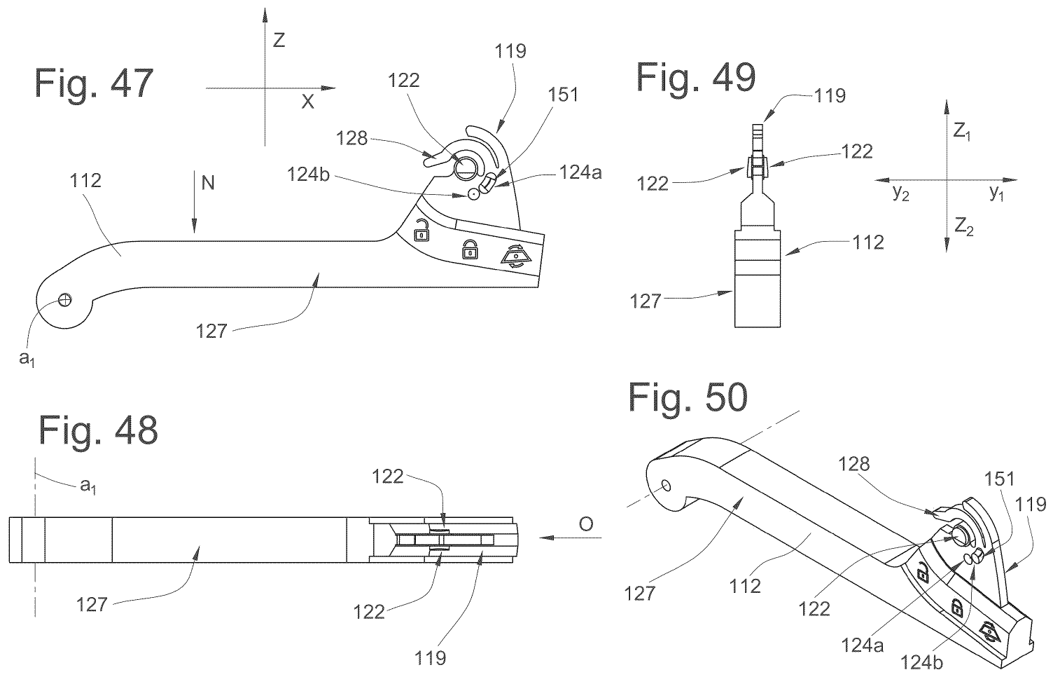

FIG. 47 is a side view of the second actuating part,

FIG. 48 is a view from the direction of the arrow N in FIG. 47,

FIG. 49 is a view from the direction of the arrow O in FIG. 48,

FIG. 50 is a perspective view of the second actuating part,

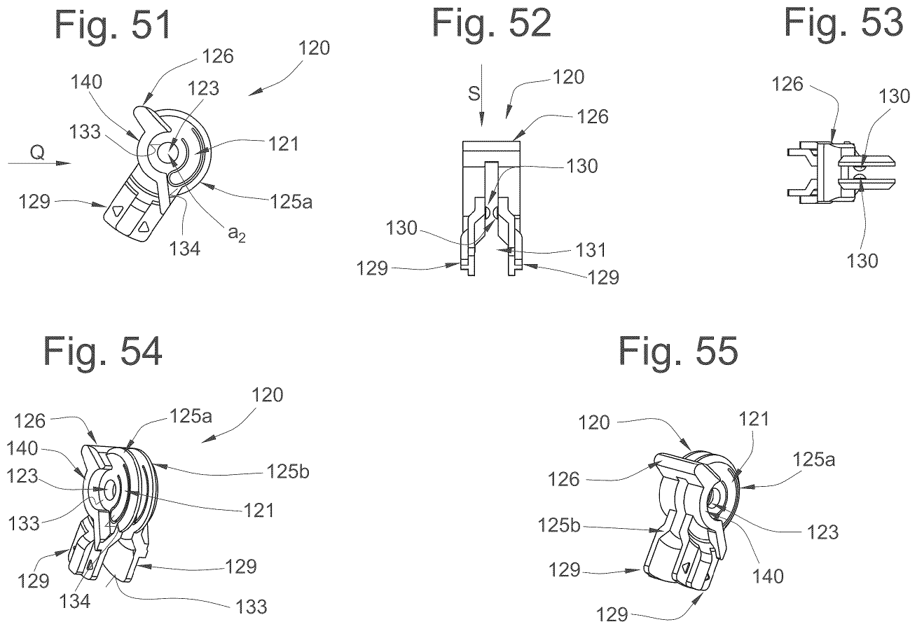

FIG. 51 is a view of the control element as an individual part,

FIG. 52 is a view from the direction of the arrow Q in FIG. 51,

FIG. 53 is a view from the direction of the arrow S in FIG. 51,

FIG. 54 is a perspective view of the control element,

FIG. 55 is another perspective view of the control element,

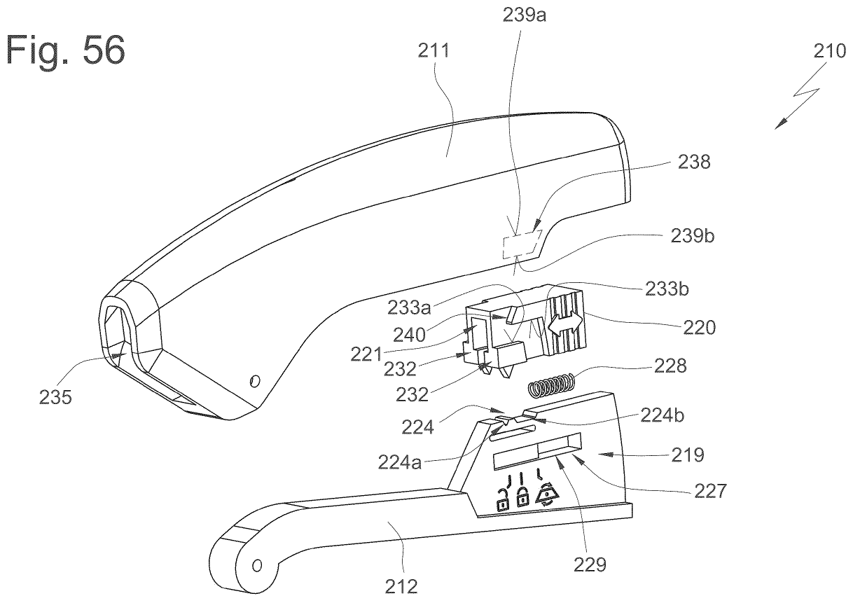

FIG. 56 is an exploded view of a third exemplary embodiment of the knife according to the invention,

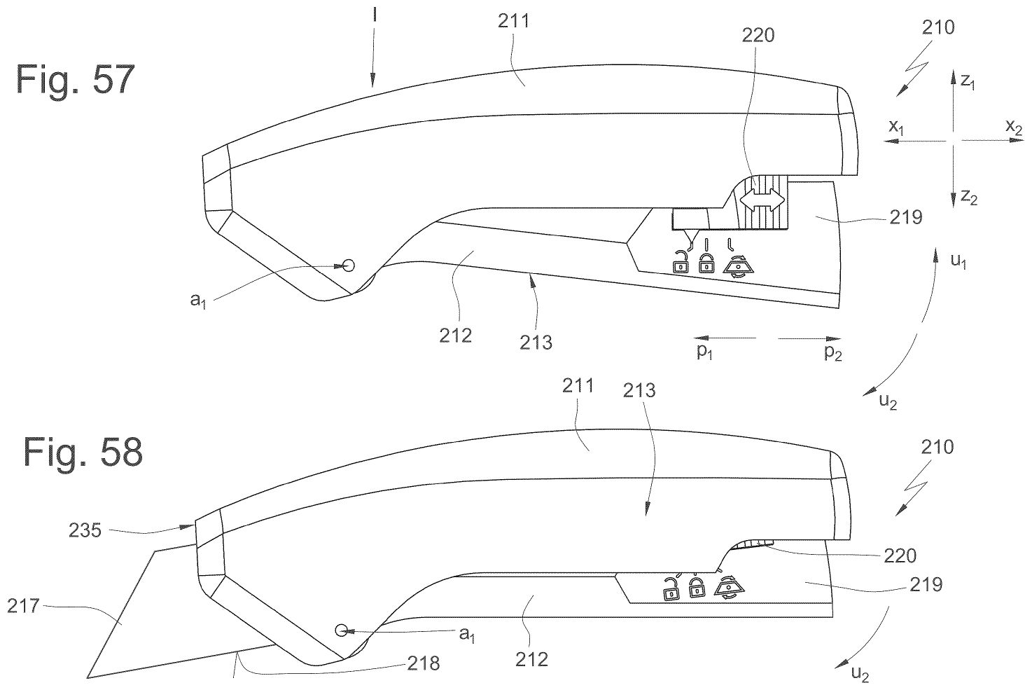

FIG. 57 is a side view of the knife according to FIG. 56, with the second actuating part being in the unactuated position and the adjustment device being set in the operating position,

FIG. 58 is a view of the knife according to FIG. 57, with the second actuating part being in the actuated position,

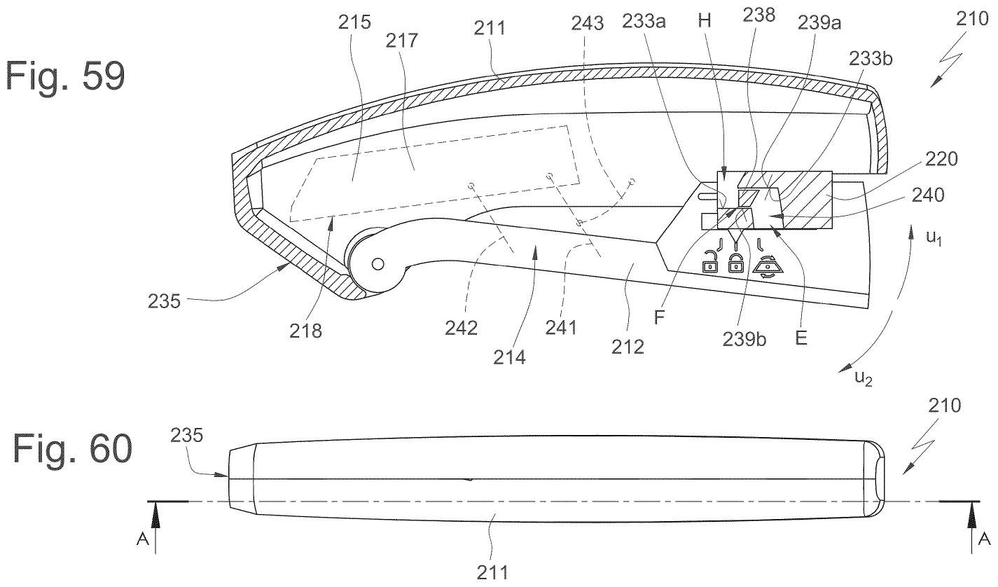

FIG. 59 is a sectional view along sectional line A₃-A₃ in FIG. 59,

FIG. 60 is a view from the direction of the arrow I in FIG. 57,

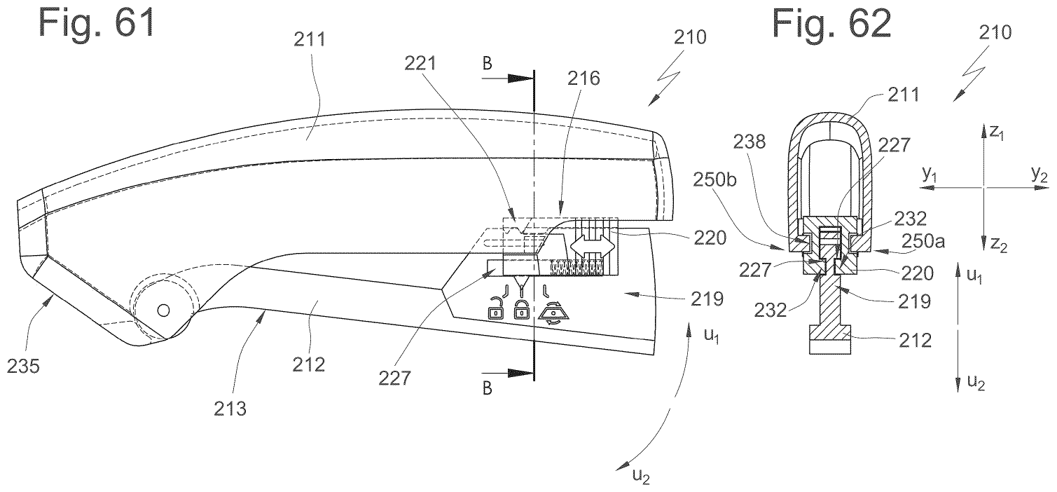

FIG. 61 is a side view according to FIG. 57, with the second actuating part being arranged in the rest position and the adjustment device being arranged in the secured position,

FIG. 62 is a sectional view along sectional line B-B in FIG. 61,

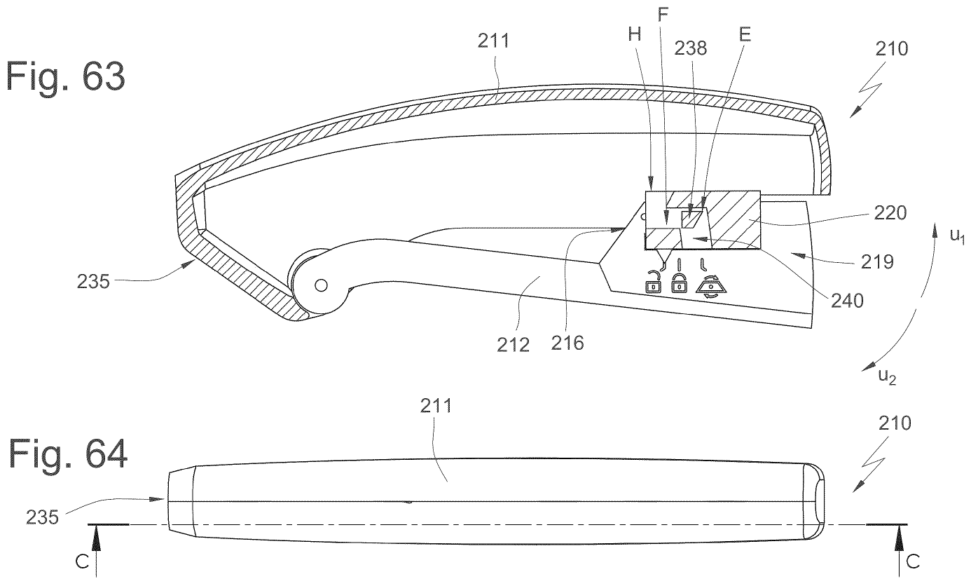

FIG. 63 is a sectional view along sectional line C-C in FIG. 64,

FIG. 64 is a plan view of the knife according to FIG. 60,

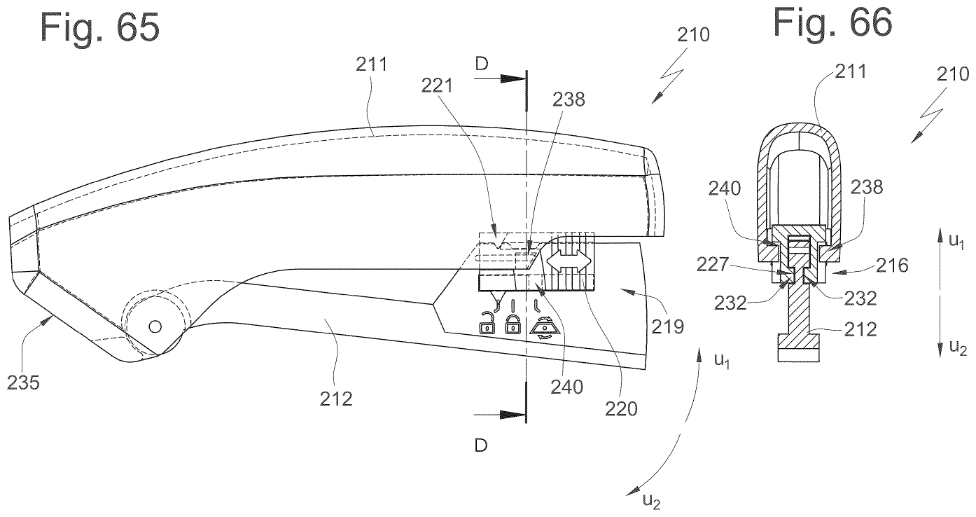

FIG. 65 is a side view according to FIG. 57, with the adjustment device being in the operating position,

FIG. 66 is a sectional view along sectional line D-D in FIG. 65,

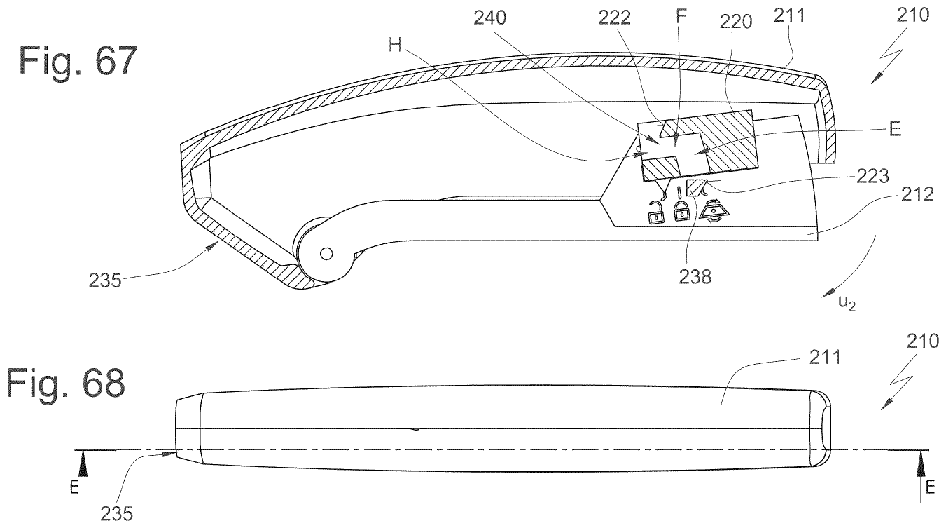

FIG. 67 is a sectional view along sectional line E-E in FIG. 68,

FIG. 68 is a plan view of the knife according to FIG. 60,

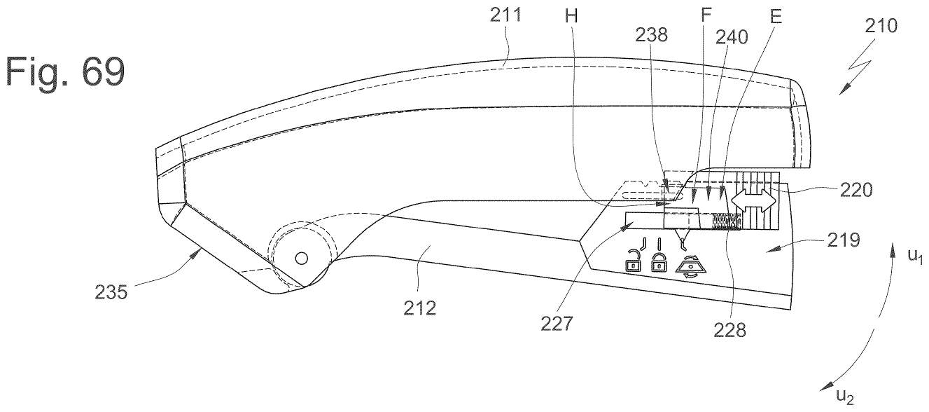

FIG. 69 is a side view according to FIG. 57, with the adjustment device being in the blade-change position,

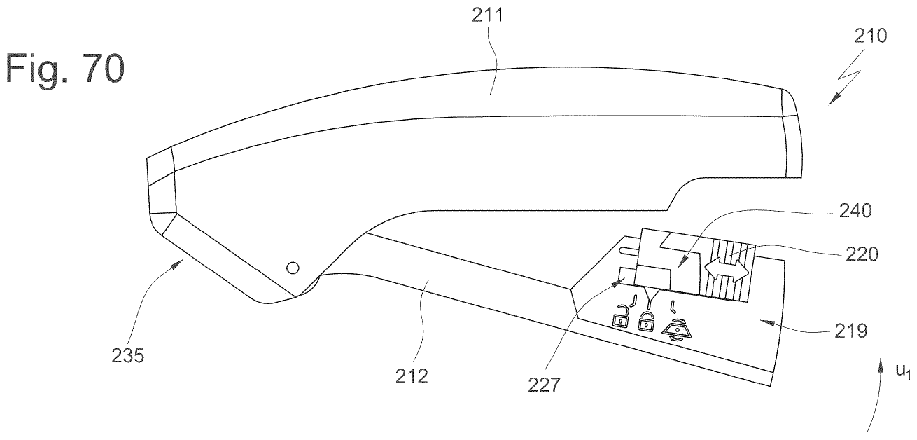

FIG. 70 is a side view of the knife, with the second actuating part being in the blade-change position,

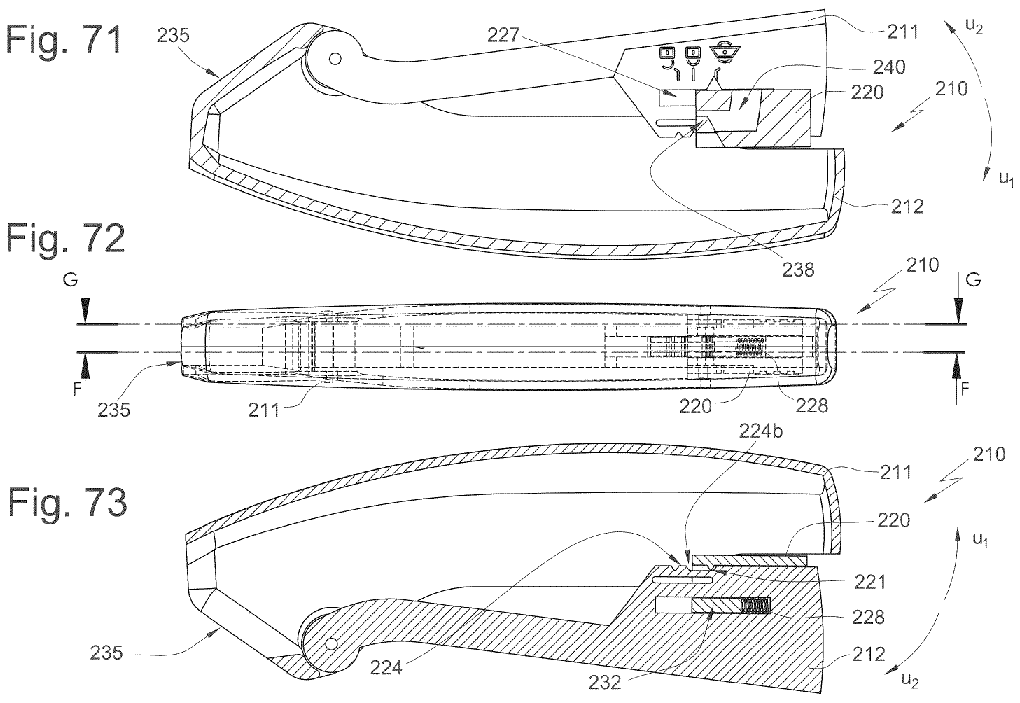

FIG. 71 is a sectional view along sectional line G-G in FIG. 72,

FIG. 72 is a plan view of the knife according to FIG. 60,

FIG. 73 is a sectional view along sectional line F-F in FIG. 72,

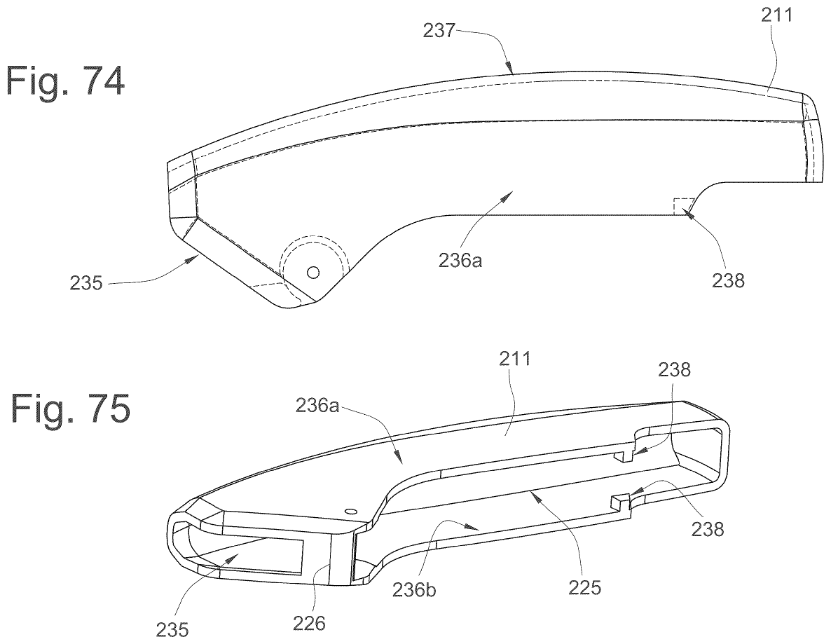

FIG. 74 is a side view of the first actuating part,

FIG. 75 is a perspective view of the first actuating part according to FIG. 74,

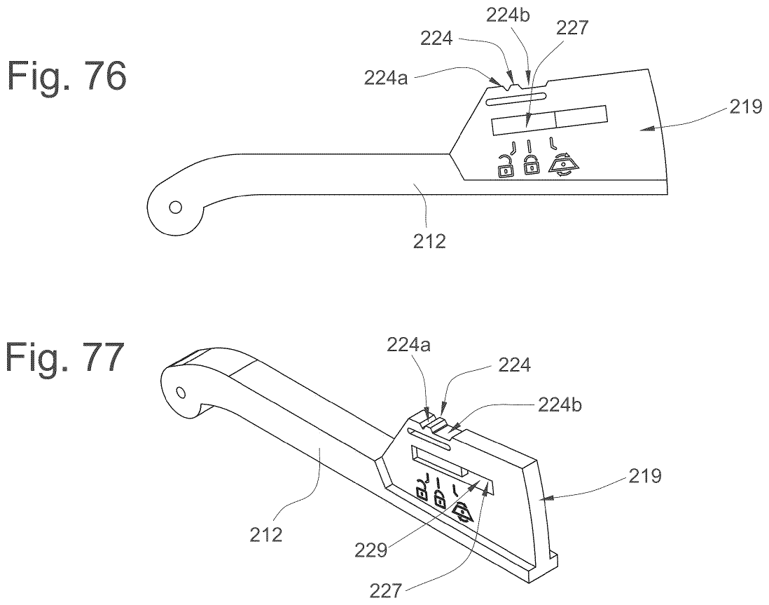

FIG. 76 is a side view of the second actuating part,

FIG. 77 is a perspective view of the second actuating part according to FIG. 76,

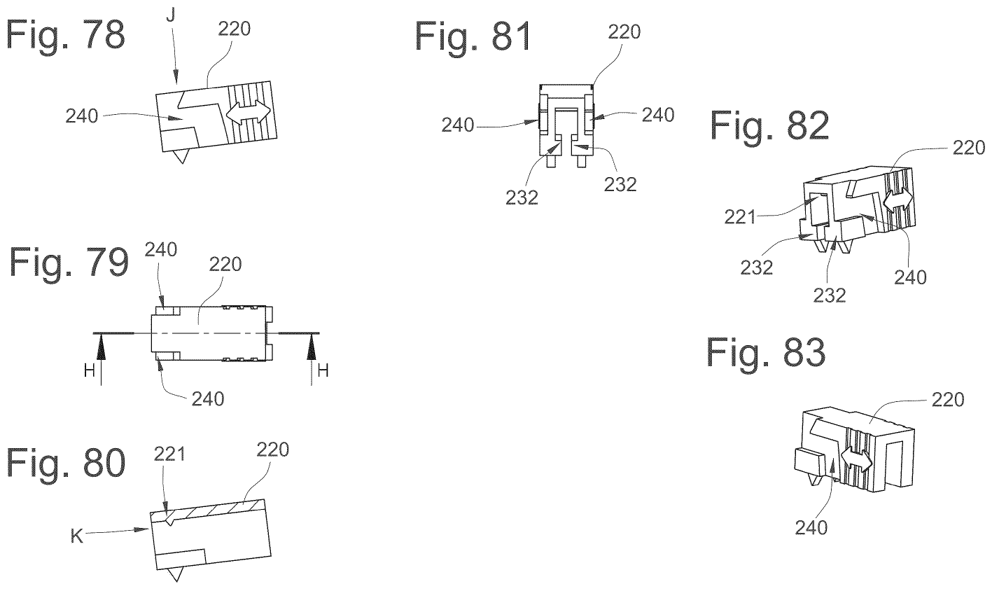

FIG. 78 is a side view of the control element,

FIG. 79 is a view from the direction of the arrow J in FIG. 78,

FIG. 80 is a sectional view along sectional line H-H in FIG. 79,

FIG. 81 is a view from the direction of the arrow K in FIG. 80,

FIG. 82 is a perspective view of the control element,

FIG. 83 is a perspective view of the control element from the other side in relation to FIG. 82.

As shown in FIG. 1, the knife 10 according to the first exemplary embodiment comprises a first actuating part 11 and a second actuating part 12 of an actuating device 13. The first actuating part 11 and the second actuating part 12 form a part joint G1 having a pivot axis a1, such that the second actuating part 12 can in principle pivot in the directions u1 and u2 relative to the first fastening part 11 out of the unactuated position shown in FIG. 1. FIG. 1 shows that the first actuating part 11 comprises a projection 19 on a rear end region 44.

The first actuating part 11 and the second actuating part 12 are part of the actuating device 13 for actuating a blade device 15 shown in FIG. 2, which also comprises an actuator 14. Within the meaning of the invention, both a blade carrier having a blade that can be detachably fastened thereto and a one-piece blade are referred to as the blade device. In this example, the knife 10 comprises a blade carrier 30 having a blade 17 detachably secured therein.

The purpose of the actuator 14 is to guide the blade device 15 and, during a relative movement of the second actuating part 12 relative to the first actuating part 11 out of the unactuated position shown in FIG. 1 into an actuated position shown in FIG. 2, to convert the movement such that the blade device 15 is moved between a rest position according to FIG. 1 and a cutting position according to FIG. 2. FIG. 2 shows a sagittal plane S of the knife 10, which extends along a central longitudinal axis of the knife. The axis a1 is approximately at right angles to the sagittal plane S.

In the rest position, the blade device 15 is therefore arranged such that parts of the knife protect the user against contact with a cutting edge 18 of the blade device 15 and, in the cutting position, the cutting edge 18 comes forward relative to the protective knife parts such that a cutting operation can be carried out. In the present exemplary embodiment, the protective knife regions are formed by the first actuating part 11. Alternatively, however, the protection could be formed by the actuating part 12 or, alternatively, by both actuating parts 11 and 12, which is also applicable to all the following exemplary embodiments.

Various configurations of the actuator are known from the prior art. In the present example (see FIG. 3), the guide comprises two connecting rods 41 and 42, which each form a joint with the second actuating part 12 and a joint with the blade device 15 in order to move the blade device 15 on a coupler curve between the rest position and the cutting position. Furthermore, a support 43 is provided as part of the actuator 14, which forms a joint with the connecting rod 41 and a joint with the first actuating part 11. This variant of the actuator 14 is, however, not limiting, but instead is merely intended to serve as an example.

It is essential that different operating states can be set in the knife 10 by means of an adjustment device 16 comprising at least one locking device, here comprising locking devices 50a and 50b, with each operating state having a defined degree of freedom of movement of the second actuating part 12 relative to the first actuating part 11. The locking devices 50a and 50b are synchronised. Each locking device 50a and 50b comprises a control element 20 that can pivot about an element pivot axis a2. As shown in FIG. 3, the pivot axis a2 is formed by pin means 22, which engage in counter pin means 23 of the second actuating part 12 and form a pivot bearing. The knife 10 is adjustable by means of the adjustment device 16 at least between an operating position, a secured position and a blade-change position. The control element 20 is adjusted in the unactuated position of the second actuating part 12.

In the secured position of the adjustment device 16, which is between the operating position and the blade-change position in the adjustment order of the control element 20, the control element 20 is set to the position shown in FIG. 4. According to FIG. 4, the second actuating part 12 is in an unactuated position relative to the first actuating part 11. In the secured position, the second actuating part 12 cannot be pivoted relative to the first actuating part 11 out of the unactuated position (see FIG. 4) into the actuated position (see FIG. 2) in the direction u1. It is also not possible for the second actuating part 12 to pivot out of the unactuated position in the direction u2 into the blade-change position (see FIG. 4).

Counter structures 27a and 27b of the control element 20 in the form of protrusions (see FIGS. 5 and 7a) form first counter surfaces 32a and 32b, which interact with securing surfaces 34a and 34b of protrusions 29a and 29b of the projection 19. A counter structure 26 in the form of a connecting piece of the control element 20 forms a counter surface 33, which interacts with a securing surface 35 of the projection 19. The securing surfaces 34a and 34b as well as the securing surfaces 35 are in the movement path of the control element 20, such that the second actuating part 12, on which the control element 20 is pivotally mounted, cannot pivot in the directions u1 and u2. FIG. 7a shows that the counter surfaces 32a and 32b as well as 33 are spaced apart from one another and are offset from one another relative to the securing surfaces 34a, 34b and 35, based on the pivot path.

FIGS. 3 and 7a show that a latching means 46, which interacts with a counter latching means 47 of the counter surface 35 and prevents the control element 20 from being unintentionally adjusted out of the secured position, is formed on the counter structure 26.

FIG. 7b shows that spring means 28 are connected to, in this case moulded onto, the control element 20, which spring means are supported on an abutment surface 31 of the second actuating part 12 and load the control element 20, in the blade-change position, into the secured position.

In the operating position of the adjustment device 16, the control element 20 according to FIGS. 8 and 9 is in a position pivoted about the pivot axis a2 in an anticlockwise manner relative to the secured position. The second actuating part 12 can be pivoted relative to the first actuating part 11 out of the unactuated position into the actuated position in the direction u1 and out of the actuated position into the unactuated position in the direction u2. In this example, the restoring of the second actuating part 12 relative to the first actuating part 11 out of the actuated position into the unactuated position is performed by a spring (not shown), which is tensioned during the movement out of the unactuated position into the actuated position. A pivoting movement of the second actuating part 12 out of the unactuated position in the direction u2 into the blade-change position is blocked in this position of the control element 20.

As shown in FIGS. 8 to 15, and in particular in FIGS. 9 and 11, in the operating position the first counter surfaces 32a and 32b interact with the first securing surfaces 34a and 34b and prevent a movement in the direction u2 out of the unactuated position of the second actuating part 12. In the direction u1, a movement out of the unactuated position into the actuated position is possible, since the securing surfaces 35 are not arranged in the movement path of the counter surfaces 33. The counter structure 26 comprising the counter surfaces 33 can be moved past the securing structure 29 comprising the second securing surfaces 35.

The actuated position is shown in FIGS. 12 to 15. In the actuated position, the securing surface 35 abuts a stopper surface 51 (see FIG. 15) of the second actuating part 12. In this position, the blade device 15 moves into the cutting position.

If the control element 20 is in the blade-change position (see FIGS. 16 and 17), the second actuating part 12 can be pivoted relative to the first actuating part 11 out of the unactuated position according to FIG. 16 in the direction u2 into a blade-change position (see FIG. 17). In this position, access to the blade device 15 is possible.

In the blade-change position of the control element 20, the counter surfaces 34a and 34b are briefly brought out of engagement with the securing surfaces 32a and 32b, such that they can move past one another (see FIG. 16). In the blade-change position, the spring means 28 load the control element 20 into the secured position. In this process, the spring means 28 are supported on the abutment surface 31 of the second actuating part 12. That is to say that the control element 20 is automatically moved back into the secured position after an adjustment into the blade-change position. In a movement of the second actuating part 12 out of the blade-change position in the direction u1 into the unactuated position, the first oblique surface 51 of the control element 20 and the second oblique surface 52 of the projection 19 come into contact and move the control element 20 into the blade-change position counter to the force of the spring means 28 until the two oblique surfaces 45 and 51 have moved past one another. When the second actuating part 12 has reached the unactuated position, the control element 20 is moved into the secured position by the spring means 28, and the second actuating part 12 cannot be moved into the actuated position or the blade-change position without actively adjusting the control element 20.

According to an alternative embodiment of the knife 10, it goes without saying that the control element 20 comprising the counter structures 26 and 27a and 27b having the counter surfaces 32a, 32b and 33 could be pivotally mounted on the first actuating part 11 and the securing surfaces 34a, 34b and 35 could be formed on a projection of the second actuating part 12.

The control element 20 comprises latching means 21, by means of which the control element 20 can be latched in two positions, namely in the operating position and the secured position, in the present example. The latching means 21 interact with counter latching means 24a and 24b (see FIGS. 7 and 11), which are formed on the second actuating part 12 in this example. In this exemplary embodiment, the latching means 21 are formed on an elastically deformable arm, the latching means 21 being able to be moved out of engagement with the counter latching means by elastic deformation of the arm.

By overcoming the minimum adjustment force on the control element 20, the latching means 21 are e.g. moved out of engagement with the counter latching means 24a, which are provided for the secured position (see FIG. 7a), in an adjustment of the control element 20 out of the secured position into the operating position, and latch to the corresponding counter latching means 24b when the operating position is reached in order to fix the operating position (see FIG. 11) of the control element 20.

FIGS. 18 to 20 show the first actuating part 11 as an individual part. The actuating part 11 is formed in a housing-like manner, and comprises a closed back 37 as well as side walls 38a and 38b. A blade exit opening 39 is formed in a front end region 36. An opening 40 is formed opposite the back 37. In the present example, the projection 19 is formed on a rear end region 44 as a plate, which has a low thickness in the Y direction and extends substantially in the x-z direction. Protrusions extend from the projection 19 on either side in the directions y1 and y2.

FIGS. 22 to 25 show the second actuating part 12 as an individual part. It comprises joint structures 48 and 49 for pivotally mounting the connecting rods 41 and 42 and a joint structure 23 for pivotally mounting the control element 20. FIG. 22 shows the abutment surface 31.

FIGS. 26 to 30 show the control element 20 as an individual part. In this example, the spring means 28 and the latching means 21 are moulded onto the control element 20. They could, however, alternatively be fastened thereto. The pin means 22 are also moulded on.

In this example, the control element 20 (see FIGS. 25 to 29) comprises two side plates 25a and 25b, which are interconnected by a connecting piece 26. In addition, the protrusions 27a and 27b, which extend towards one another in the y direction to form an intermediate space between the side plates 25a and 25b, are formed on the side plates 25a and 25b. The first counter structures 27a and 27b form the first counter surfaces 32a and 32b, which, together with the first securing surfaces 34a and 34b of the securing structure 29, can prevent a pivoting movement of the second actuating part 12 in the direction u2, while the second counter structures 26 form the second counter surfaces 33, which, together with the second securing surfaces 35, can prevent a movement of the second actuating part in the direction u1, depending on the position of the control element 20.

A second exemplary embodiment is shown in FIGS. 30 to 55. The knife as a whole is denoted by reference sign 110. The knife 110 according to the second exemplary embodiment substantially corresponds to the first exemplary embodiment. It differs in respect of the adjustment device 116.

In this exemplary embodiment, a blade device 115 is shown merely schematically by a dashed line in FIG. 33. An actuator 114 is also merely schematically indicated, since, as in the first exemplary embodiment, different embodiments of the actuator can be used. For example, the blade device 115 and an actuator 114 are designed in the same way as in the first exemplary embodiment. The blade device 115 comprises a blade carrier comprising a blade 117 and a cutting edge 118 formed thereon. In this exemplary embodiment, the actuator 114 has the same function as in the first exemplary embodiment, but can be configured differently. The guide of the blade device 115 comprising two connecting rods corresponds e.g. to the first exemplary embodiment.

According to FIG. 30, the parts of the knife 110 that are essential to the invention are shown in an exploded view. The knife 110 comprises a first actuating part 111 and a second actuating part 112 of an actuating device 113, which also comprises the actuator 114. The actuating parts 111 and 112 together form a pivot joint G1 having the pivot axis a1 and are each elongate, similarly to the way in which a pair of pliers is actuated. The pivot joint G1 is located at a front end region of the knife 110.

The first actuating part 111 is shown in FIGS. 45 and 46. It comprises a back 145 and side walls 146a and 146b which adjoin it, are formed to be opposite and form an interior space 141 therebetween. The first actuating part 111 forms a lower opening 135 and a blade exit opening 136. In a central region 147 arranged between a front end region 143 and a rear end region 144, the side walls 146a and 146b have a height H2 which is lower relative to a height H1 in a region positioned closer to the front end 137. In this configuration, the side walls 146a and 146b conceal essential parts of the guide device for the blade device 115 and the actuator 114 at least in part.

A counter securing structure 138 which protrudes into the receiving space 141 and is part of locking devices 150a and 150b of the adjustment device 116 is formed on both side walls 146a and 146b in the rear end region 144. In FIG. 45, the securing structure 138 is concealed and shown by a dashed line. As shown in FIG. 46, for example a connecting structure 148 can interconnect the side walls 146a and 146b on a lower face and separate the openings 135 and 136 from one another. The connecting structure 148 is used to increase the stability of the first actuating part. The receiving space 141 is delimited by a rear wall 149 on the rear end region 144.

The second actuating part 112 is shown in FIGS. 47 to 50. The second actuating part 112 is provided with a projection 119 at an end region opposite the pivot axis a1. The projection 119 is planar and extends substantially in the x-z plane. Pin means 122 protrude from the projection 119 on either side in the directions y1 and y2. These are provided in order to form a pivot joint G2 for pivotally mounting the control element 120 about an element pivot axis a2 together with complementary counter pin means 123 of the control element 120. This axis is formed at right angles to a sagittal plane S, which is shown in FIG. 32 and is positioned in the same way as in the first exemplary embodiment.

A spring means 128 is formed on the projection 119, the function of which will be explained below. Furthermore, the projection 119 is provided with counter latching means 124a and 124b, which interact with latching means 121 of a control element 120 in order to fix the control element 120 in the operating position and to prevent a movement into the operating position in the secured position. They can e.g. be in the form of a protrusion/recess pair.

Guide means 151 are provided adjacently to the counter latching means 124a, which guide means guide the latching means 121, which are moved out of engagement with the counter latching means 124a or 124b when the control element 120 is set into the blade-change position, back into engagement with the counter latching means 124b of the secured position when returning to the secured position. The guide means 151 can e.g. be in the form of a groove.

The control element 120 is shown in FIGS. 51 to 55. It comprises two plate regions 125a and 125b, between which a portion of the projection 119 can be arranged. The pin means 122 of the projection 119 are designed to interact with counter pin means 123 of the control element 120, forming a pivot joint G2. The plate regions 125a and 125b are interconnected by a connecting piece 126. The connecting piece 126 forms a supporting surface for the spring means 128.

Actuating lugs 129, which are provided for setting the adjustment device 116, extend from both plate regions 125a and 125b. In this exemplary embodiment, the latching means 121 are formed in each of the plate regions 125a and 125b by a tab cut out from the relevant plate region, which is only connected to the material of the relevant plate region 125a or 125b at an end region. As shown in FIGS. 52 and 53, for example, a protrusion 130 is formed on each latching means 121, the protrusions 130 of the two latching means 121 facing one another and pointing towards an intermediate space 131 between the plate regions 125a and 125b.

A counter structure 140 that is formed as a wall and comprises a partially circular cylindrical counter surface 133 protrudes coaxially in parallel with the pivot axis a2 from each plate region 125a and 125b in the directions y1 and y2, each counter structure being part of one of two synchronised locking devices 150a or 150b and being provided for interacting with the securing structure 138 on each of the side walls 146a and 146b of the first actuating part 111 in order to block a movement of the second actuating part 112 relative to the first actuating part 111 in the direction u1 and/or in the direction u2. A securing surface 134 (see FIGS. 51 and 54) is designed to automatically guide the securing structure and the counter structure into engagement when the second actuating part 112 has previously been adjusted into the blade-change position.

In the same way as in the first exemplary embodiment, the adjustment device 116 is adjustable between a secured position, an operating position and a blade-change position.

In the secured position (see FIGS. 31 to 35), a movement out of the unactuated position in the direction u1 into the actuated position and the blade-change position is not possible. According to the sectional view in FIG. 33, the counter surface 133 interacts with the securing surface 139 of the securing structure 138. In this case, the counter surface 133 surrounds the securing surface 139 such that a surface region 133a of the surface 133 interacts with a surface region 139a of the surface 139 and a surface region 133b arranged to be diametrically opposite the surface 133a interacts with a surface region 139b, and this prevents a movement of the second actuating part 112 out of the unactuated position in the directions u1 and u2. Both a movement of the second actuating part 112 relative to the first actuating part 111 into the actuated position and a movement into the blade-change position are thus prevented.

From the secured position according to FIG. 31, which is between the operating position and the blade-change position in the adjustment order of the control element 120, the adjustment device 116 is adjustable into an operating position according to FIGS. 37 to 43 by the control element 120 being rotated in the direction p1. In the operating position of the control element 120, the knife 110 is adjustable between an unactuated position (see FIGS. 37 to 40) and an actuated position (see FIGS. 41 to 43). The second actuating part 112 can be set out of the unactuated position (see FIGS. 37 to 40) into the actuated position (see FIGS. 41 to 43) in the direction u1 and can be set out of the actuated position into the unactuated position in the direction u2.

FIG. 40 in particular shows that the counter surface 133 of the control element 120 interacts with the securing surface 139 such that a movement of the second actuating part 112 in the direction u2 is prevented, while a movement in the direction u1, into the actuated position, is readily possible. FIG. 40 shows that, in the operating position of the control element 120, the surface region 133a interacts with the surface region 139a to block a movement of the second actuating part 112 in the direction u2, while the surface regions 133b and 139b can be moved past one another when the second actuating part 112 moves in the direction u1.

In the unactuated position according to FIG. 36, the blade device 115 is in a rest position in which the cutting edge 118 of the blade 117 is shielded by knife regions against being contacted such that it is inaccessible. In the present example, the first actuating part 111 forms these protective regions, but alternatively, the second actuating part 112 or alternatively the first actuating part 111 and the second actuating part 112 could also form these regions.

In the actuated position, the blade device 115 is in a cutting position (see FIG. 41) such that the cutting edge 118 protrudes relative to the shielding knife parts. In the present example, the cutting edge 118 exits from an opening 136 in the first actuating part 111 in the actuated position and protrudes relative to a front knife end 137. In the actuated position (see FIG. 43), a securing surface 134 of the control element 120 interacts with the counter securing structure 138 and prevents a movement of the control element 120 in the direction p2 into the secured position.

A rotation of the control element 120 out of the secured position according to FIG. 32 in the direction p2 moves the adjustment device 116 out of the secured position into the blade-change position (see FIG. 44a). In the blade-change position, a movement of the second actuating part 112 out of the unactuated position in the direction u1 into the actuated position is not possible, but a movement in the direction u2 into the blade-change position according to FIG. 44 can be performed, such that it is possible to access the blade device 115 and change the blade 117. FIG. 44a shows that the surface regions 133b and 139b prevent a movement of the second actuating part 112 in the direction u1, but the surface regions 133a and 139a can be moved past one another such that a movement of the second actuating part 112 in the direction u2 is possible.

The spring means 128 of the projection 119 (see FIG. 44c) abut the connecting piece 126 of the control element 120 in the secured position. In a movement of the control element 120 into the blade-change position, the spring means 128 are elastically deformed and load the control element 120 out of the blade-change position into the secured position.

The latching means 121 are moved out of engagement with the counter latching means 124b and into engagement with guide means 151 when the control element 120 moves out of the secured position into the blade-change position (in this exemplary embodiment, counter to the spring force of the spring means 128). When the control element 120 makes the return movement (which, in this exemplary embodiment, is performed by the restoring force of the spring means 128, but alternatively can also be done manually) into the secured position, the latching means 121 are guided into engagement with the counter latching means 124b by the guide means 151, the control element 120 moving into the secured position.

If the second actuating part 112 is pivoted out of the blade-change position in the direction u1 back into the unactuated position, setting surfaces 152 of the connecting piece 126 collide with the securing structures 138, as a result of which the control element 120 is briefly moved into the blade-change position such that the counter surface 133 can move into engagement with the securing surface 139. Once the counter surface 133 and the securing surface 139 are engaged, no force acts on the setting surface 152 and the spring means 128 move the control element 120 back into the secured position, the latching means 121 moving into engagement with the counter latching means 124b.

A third exemplary embodiment is shown in FIGS. 56 to 83. In principle, the knife 210 according to the third exemplary embodiment corresponds to the first two exemplary embodiments, but it differs in respect of the adjustment device 216. The adjustment device 216 comprises two locking devices 250a and 250b.

In this exemplary embodiment, for the sake of clarity, a blade device 215 is shown merely schematically by a dashed line in FIG. 59. In the present exemplary embodiment, it comprises a blade carrier having a blade 217 detachably secured therein, which has a cutting edge 218, which is shown merely in the form of a dashed line in FIG. 59. It is, however, formed in accordance with the first exemplary embodiment. Alternatively, however, the blade device 215 could e.g. also be formed in one piece.

According to FIG. 56, in this exemplary embodiment, the knife comprises, in accordance with the first exemplary embodiment, a first actuating part 211 and a second actuating part 212 of an actuating device 213. The actuator 214 is likewise designed in the same way as in the first exemplary embodiment, in order to move the blade device 215 between the rest position and the cutting position. In this exemplary embodiment, the actuator 214 comprises a guide for the blade device 215 comprising two connecting rods 241 and 242, which are each pivotally mounted on the second actuating part 212 and on the blade device 215. A support 243 is supported on the first actuating part 211 and forms a pivot joint with the connecting rod 241. The invention does not come down to the configuration of the actuator 214 of the actuating device 213, however. It may alternatively also be designed differently. The actuating parts 211 and 212 and the adjustment device 216, which will be described in the following, are essential.

In this example, the second actuating part 212 comprises a projection 219, on which the control element 220 is mounted so as to be translationally movable. In this example, the control element 220 is linearly movable in the directions p1 and p2, but, alternatively, it could also be movable on a curved path or on a path of any shape.

The control element 220 is loaded into the secured position by spring means 228. The spring means 228 are received in a spring seat 229 on a guide 227 of the projection 219. The guide is formed in one region as a groove and in another region as a through-opening on either side of the projection 219. The through-opening forms the spring seat in which the spring means 228 are arranged. The guide 227 is used to guide the control element 220.

The function of the control element 220 is the same as that in the first and the second exemplary embodiment, i.e. the control element 220 can be set into an operating position, a secured position and a blade-change position by being moved.

The control element 220 is provided with protrusions 232 that are directed inwards towards one another and engage in the guide 227. In this way, the movement of the control element 220 is guided and limited by the guide 227. The control element 220 is thus also securely fixed to the projection 219. Furthermore, counter latching means 224a, 224b which interact with latching means 221 of the control element 220 are formed on the projection 219.

The latching means 221 protrude into an interior space in the U-shaped control element 220. The control element 220 can be latched in an operating position by means of the latching means 221 and the counter latching means 224a and 224b. If the control element 220 is moved out of the latching structure 224a of the operating position, the latching structure 224a allows the control element 220 to move into the secured position and into the blade-change position. The movement between the latching structures 224a and 224b is possible due to an increased actuation force on the control element 220. The spring means 228 load the control element 220 into the secured position.

The control element 220 comprises a counter structure 240 comprising counter surfaces 233a and 233b, which interact with a securing structure 238 comprising securing surfaces 239a and 239b of the first actuating part 211. The securing structure 238 is positioned in a receiving space 225 in the first actuating part 211 and is therefore merely shown by a dashed line in FIG. 56. In FIG. 56, the second actuating part 212 is shown in a position in which it is unactuated relative to the first actuating part 211. FIG. 58 shows the actuated position.

In the secured position (see FIGS. 59 to 62) of the control element 220, which is between the operating position and the blade-change position in the adjustment order, the securing structure 238 is arranged in a central region F of the counter structure 240. The securing surface 239a interacts with a counter surface 233b and the securing surface 239b interacts with a counter surface 233a. The second actuating part cannot be moved either in the direction u1 or in the direction u2. The blade device 215 therefore cannot be moved out of the rest position. It remains in the rest position, in which the blade 217, in particular the cutting edge 218, is prevented from being contacted by protective means of the first actuating part 211. A movement of the second actuating part 212 relative to the first actuating part 211 in the direction u2 into the blade-change position is not possible.

If the control element 220 is arranged in the operating position (see FIGS. 65 to 68), the securing structure 238 is in a region E of the counter structure 240. In the operating position, the second actuating part 212 can be moved out of the unactuated position into the actuated position, with the blade device 215 being moved out of the rest position into the cutting position and the blade 217 comprising the cutting edge 218 exiting through the opening 235 in the first actuating part 211. The securing surface 239a and the counter surface 233b prevent a movement of the second actuating part 212 into the blade-change position.

In the blade-change position (see FIGS. 69 to 73) of the control element 220, the securing structure 238 is arranged in the region H of the control element 220. In this position, a movement in the direction u1 into the actuated position is blocked by the counter surface 233a and the securing surface 239b interacting. A movement of the second actuating part 212 relative to the first actuating part 211 in the direction u2 into the blade-change position is possible. The control element 220 has to be adjusted into the blade-change position counter to spring force and is moved back into the secured position by the spring means 228 when the user stops applying force.

When the second actuating part 212 is returned to the unactuated position (see FIG. 71), an oblique surface 222 of the counter structure 240 as well as an oblique surface 223 of the securing structure 238 come into contact and move the control element 220 into the blade-change position. Once the oblique surface 222 has passed the oblique surface 223, the control element 220 is adjusted into the secured position by the spring means 228 in the unactuated position of the second actuating element 212. The knife is thus in a secured state and, after changing the blade, it is not possible to unintentionally move the blade device 215 into the cutting position. In other words, there is no risk that the second actuating part 212 is inadvertently adjusted into the actuated position after changing the blade. The risk of injury is thus considerably reduced.

FIG. 73 shows that the latching means 221 are in engagement with the counter structure 224b of the counter latching means 224.

In the side view of the housing-like first actuating part 211 according to FIG. 74, the securing structure 238 is shown by a dashed line. FIG. 75 shows that the securing structures 238 are formed on both opposite side walls 236a and 236b of the knife 210. FIG. 75 also shows that a lower face of the knife 210 opposite the knife back 237 is open towards the receiving space 225, except for a connecting piece 226 connecting the side walls 236a and 236b.

The second actuating part 212 is shown in a side view in FIG. 76 and in a perspective view in FIG. 77. The guide 227 and the counter latching means 224 comprising the counter structures 224a and 224b are shown. Although only one guide 227 is shown in FIG. 77, guides 227 are formed on either side of the projection 219. The spring seat 229 is also shown in the region of the guide 227.

The control element 220 is shown in FIGS. 78 to 83. FIGS. 79 and 81 show the counter structure 240 formed on either side of the control element 220. The sectional view according to FIG. 80 shows the latching means 221, which interact with counter latching means 224 of the second actuating part 212. FIGS. 81 and 82 show the protrusions 232, which engage in the guides 227 and guide the control element 220.

1-15. (canceled)

16. A knife, comprising: a blade device; a first actuating part; a second actuating part of an actuating device, which forms a joint together with the first actuating part and is pivotable in a first direction out of an unactuated position about a part pivot axis relative to the first actuating part in order to move the blade device from a rest position into a cutting position and is pivotable in a second direction in order to move the second actuating part into a blade-change position; and an adjustment device having a control element by which different degrees of freedom are settable with regard to the movement of the second actuating part relative to the first actuating part so that, depending on the setting of the control element in the operating position or the blade-change position, a first or a second of the pivot directions is blocked or both pivot directions are blocked when the secured position is set.

17. The knife according to claim 16, wherein the adjustment device is configured so that, in relation to a control order of the control element, the secured position setting is arranged between the blade-change position setting and the operating position setting.

18. The knife according to claim 16, wherein the control element is translationally or rotationally movable between the operating position, the secured position and the blade-change position.

19. The knife according to claim 16, wherein counter surfaces of the control element are arranged coaxially with a pivot axis of the control element in the unactuated position.

20. The knife according to claim 16, wherein a securing surface of the adjusting device and a counter surface of the control element extend in directions which are parallel to a pivot axis of the control element.

21. The knife according to claim 20, wherein the securing surface and/or the counter surface are partially circular cylindrical.

22. The knife according to claim 20, wherein the securing surface and the counter surface are formed on a rear end region of the knife.

23. The knife according to claim 22, wherein the securing surface and/or the counter surface are formed on a projection of the relevant actuating part.

24. The knife according to claim 16, wherein the control element includes a latch that is movable into interlocking engagement with a counter latch in at least one of the secured position, the operating position and the blade-change position.

25. The knife according to claim 16, wherein the control element includes a restoring element formed as a spring that loads the control element into the secured position.

26. The knife according to claim 16, further comprising a securing structure having at least one securing surface and a counter structure having at least one counter surface, wherein the securing structure and the counter structure have oblique surfaces so as to move the control element out of the blade-change position into the unactuated position when the second actuating part moves so that the securing surface and the counter surface are movable past one another.

27. The knife according to claim 16, wherein the adjustment device includes two locking devices that are synchronized with one another.

28. The knife according to claim 27, wherein parts of a first of the locking devices and parts of a second of the locking devices are assigned to the control element.

29. The knife according to claim 16, wherein the part pivot axis is arranged approximately at right angles to a sagittal plane.

30. The knife according to claim 16, wherein a pivot axis of the control element is arranged approximately in parallel with the part pivot axis.
